(19) United States
(12) Patent Application Publication
(10) Pub. No.: US 2016/0137766 A1
(43) Pub. Date: May 19, 2016

(54) (METH)ACRYLIC POLYMER, (METH)ACRYLIC RESIN COMPOSITION, (METH)ACRYLIC RESIN SHEET, (METH)ACRYLIC RESIN LAMINATED ARTICLE AND COMPOSITE SHEET

(71) Applicant: MITSUBISHI RAYON CO., LTD., Tokyo (JP)

(72) Inventors: Hiroshi Okafuji, Otake-shi (JP); Masahiko Ono, Otake-shi (JP); Osamu Kawai, Otake-shi (JP); Shogo Okazaki, Otake-shi (JP)

(73) Assignee: Mitsubishi Rayon Co. Ltd., Chiyoda-ku, TK (JP)

(21) Appl. No.: 14/900,871

(22) PCT Filed: Jun. 23, 2014
(86) PCT No.: PCT/JP2014/066500

§ 371 Date: Dec. 22, 2015

(30) Foreign Application Priority Data
Jun. 24, 2013 (JP) 2013-131319

(51) Int. Cl. C08F 220/14; B32B 27/30; C08L 33/12

(52) U.S. Cl. CPC C08F 220/14; C08L 33/12; B32B 27/308; B32B 2250/24

(57) ABSTRACT

A (meth)acrylic polymer, a (meth)acrylic resin sheet containing same, a (meth)acrylic resin laminated article obtained by laminating a functional layer on one or both sides of a (meth)acrylic resin sheet, and a composite sheet containing said article. Said polymer contains 4.5-7.5% by mass of units of (a) an acrylate having a C1-11 hydrocarbon group and one ethylenically unsaturated bond in the molecule, 0.3-3.2% by mass of units of (b) a monomer having two or more ethylenically unsaturated bonds in the molecule, and 89.3-95.2% by mass of units of (c) a (meth)acrylate other than the monomer units.

### TECHNICAL FIELD

The present invention relates to a (meth)acrylic polymer, a (meth)acrylic resin composition, a (meth)acrylic resin sheet, a (meth)acrylic resin laminated article, and a composite sheet.

### BACKGROUND ART

A transparent resin like acrylic resin and polycarbonate resin is widely used as various materials including industrial materials and constructional materials. In recent years, from the viewpoint of its transparency and impact resistance in particular, it is also used as a front panel of various displays including CRT, a liquid crystal television, and a plasma display.

Recently, it is required for a front panel for display to have various surface functions like anti-reflection function, anti-glare function, hard coat function, anti-static function, and anti-soiling function.

As a method for producing a resin sheet having those various surface functions, a dipping method can be mentioned, for example. However, the dipping method has a problem of low productivity due to batch processing.

As another method for production, there is a method including attaching, via an ultraviolet-curable adhesive layer, a functional film formed on a substrate film onto a surface of a transfer subject, solidifying the adhesive layer by ultraviolet (UV) ray irradiation, and peeling the substrate film, and transferring a functional layer on a surface of the transfer subject (hereinbelow, referred to as a “UV laminate transfer method”). This method is described in Patent Document 1, for example.

Meanwhile, an acrylic resin is disadvantageous in that it has a high water absorbing property and easily exhibits a shape change like warpage as caused by absorbed water, if it is applied to a front panel of a display, in particular.

As a method of improving the water absorbing property of an acrylic resin, a method of copolymerizing methacrylic acid ester, in which methyl methacrylate and alicyclic hydrocarbon group are bonded to each other via ester bond, is known. For example, in Patent Document 2, a method of producing an acrylic resin panel by polymerization of an acrylic syrup, which contains a mixture of a polymer that is obtained by polymerizing a polymerizable monomer containing methyl methacrylate and at least two (meth)acrylic acid esters selected from a group consisting of methyl methacrylate, (meth)acrylic acid ester having a specific alicyclic hydrocarbon group, and (meth)acrylic acid ester having a specific linear or branched hydrocarbon group, and, by having a specific composition ratio, satisfies specific refractive index condition, is described.

### CITATION LIST

### Patent Document

Patent Document 1: JP 2000-158599 A

Patent Document 2: JP 2012-31351 A

### SUMMARY OF THE INVENTION

### Problem to be Solved by the Invention

Recently, it is required to have an acrylic resin panel with suppressed warpage under conditions with higher temperature and higher humidity. However, it is difficult to obtain a panel having sufficient effect of suppressing warpage. Furthermore, although the UV laminate transfer method allows production of a laminated article with good productivity by using relatively simple facilities, there is a problem that it is difficult to have adhesiveness between a functional layer and an acrylic resin having excellent low water absorbing property.

An object of the present invention is to provide a (meth)acrylic resin sheet having low water absorbing property, excellent heat resistance and transparency, and good adhesiveness for a functional layer, and a (meth)acrylic polymer and a (meth)acrylic resin composition that are suitable for producing the resin sheet.

Another object of the present invention is to provide a (meth)acrylic resin laminated article having a functional layer laminated on the (meth)acrylic resin sheet, and a composite sheet having the (meth)acrylic resin laminated article laminated on a surface of a thermoplastic resin substrate.

### Means for Solving Problem

According to the present invention, there is provided a (meth)acrylic polymer (A) containing:

4.5 to 7.5% by mass of a monomer (a) unit;

0.3 to 3.2% by mass of a monomer (b) unit; and

89.3 to 95.2% by mass of a monomer (c) unit,

in which the monomer (a) unit is an acrylic acid ester unit having a hydrocarbon group with 1 to 11 carbon atoms and one ethylenically unsaturated bond in the molecule, the monomer (b) unit is a monomer unit having two or more ethylenically unsaturated bonds in the molecule, and the monomer (c) unit is a (meth)acrylic acid ester unit other than the monomer units.

Furthermore, according to the invention, there is provided a (meth)acrylic resin composition containing 100 parts by mass of the (meth)acrylic polymer (A) and 0.002 to 0.7 part by mass of an olefin-alkyl(meth)acrylate copolymer (B).

Furthermore, according to the invention, there is provided a (meth)acrylic resin sheet containing the (meth)acrylic polymer (A).

Furthermore, according to the invention, there is provided a (meth)acrylic resin sheet containing the (meth)acrylic resin composition.

Furthermore, according to the invention, there is provided a (meth)acrylic resin laminated article containing the (meth)acrylic resin sheet and a functional layer laminated on at least one surface of the (meth)acrylic resin sheet.

Furthermore, according to the invention, there is provided a composite sheet containing a thermoplastic resin substrate and the (meth)acrylic resin laminated article that is laminated on at least one surface of the thermoplastic resin substrate, in which lamination is performed such that the (meth)acrylic resin sheet surface of the (meth)acrylic laminated article is in contact with the thermoplastic resin substrate surface.

Furthermore, according to the invention, there is provided a composite sheet containing a thermoplastic resin substrate, the (meth)acrylic resin laminated article that is laminated on one surface of the thermoplastic resin substrate, and a functional layer that is laminated on the other surface of the thermoplastic resin substrate, in which lamination is performed such that the (meth)acrylic resin sheet surface of the (meth)acrylic resin laminated article is in contact with the thermoplastic resin substrate surface.

### Effect of the Invention

According to an embodiment of the present invention, a (meth)acrylic resin sheet having low water absorbing property, excellent heat resistance and transparency, and good adhesiveness for a functional layer, and a (meth)acrylic polymer and a (meth)acrylic resin composition that are suitable for producing the resin sheet can be provided.

Furthermore, according to other embodiment of the present invention, a (meth)acrylic resin laminated article having a functional layer laminated on the (meth)acrylic resin sheet, and a composite sheet having the (meth)acrylic resin laminated article laminated on a substrate can be provided.

### BRIEF DESCRIPTION OF DRAWINGS

FIG. 1 is a conceptual diagram illustrating a method for measuring the droop ratio of a sheet test sample.

### MODE(S) FOR CARRYING OUT THE INVENTION

The (meth)acrylic polymer (A) according to the embodiment of the present invention contains the acrylic acid ester (a) unit having a hydrocarbon group with 1 to 11 carbon atoms and one ethylenically unsaturated bond in the molecule, the monomer (b) unit having two or more ethylenically unsaturated bonds in the molecule, and the (meth)acrylic acid ester (c) unit other than the aforementioned monomer (a) and (b) units.

When the total amount of the monomers (a), (b), and (c) is 100% by mass, it is preferable that content of the monomer (a) unit is in the range of 4.5 to 7.5% by mass, content of the monomer (b) unit is in the range of 0.3 to 3.2% by mass, and content of the monomer (c) unit is in the range of 89.3 to 95.2% by mass.

The monomer (c) unit is the methyl methacrylate (c1) unit, the methacrylic acid ester (c2) unit having alicyclic hydrocarbon group with 6 to 20 carbon atoms, and a methacrylic acid ester unit other than the methacrylic acid ester (c2) unit, and it may contain the methacrylic acid ester (c3) unit having hydrocarbon group with 3 to 10 carbon atoms. The monomer (c2) is preferably isobornyl methacrylate and the monomer (c3) is preferably t-butyl methacrylate.

The (meth)acrylic resin composition according to an embodiment of the present invention contains the (meth)acrylic polymer (A) and the olefin-alkyl(meth)acrylate copolymer (B).

The composition preferably contains 0.002 to 0.7 part by mass of the olefin-alkyl(meth)acrylate copolymer (B) relative to 100 parts by mass of the (meth)acrylic polymer (A).

The olefin-alkyl(meth)acrylate copolymer (B) is preferably the ethylene-alkyl(meth)acrylate copolymer (B-1), and more preferably the ethylene-alkyl acrylate copolymer (B-2). Content of the alkyl acrylate unit in the ethylene-alkyl acrylate copolymer (B-2) is preferably in the range of 15 to 40% by mass.

The (meth)acrylic resin sheet according to an embodiment of the present invention contains the (meth)acrylic polymer (A) or the (meth)acrylic resin composition.

The (meth)acrylic resin laminated article according to an embodiment of the present invention includes the aforementioned (meth)acrylic resin sheet and a functional layer laminated on at least one surface of the sheet. A functional layer may be laminated on both surfaces of the sheet.

The composite sheet according to an embodiment of the present invention contains a thermoplastic resin substrate and the (meth)acrylic resin laminated article that is laminated on at least one surface of the thermoplastic resin substrate. The lamination is performed such that the (meth)acrylic resin sheet surface of the (meth)acrylic resin laminated article is in contact with the thermoplastic resin substrate surface. It is also possible that the (meth)acrylic resin laminated article is laminated on one surface of the thermoplastic resin substrate and a functional layer is laminated on the other surface. Thickness of the thermoplastic resin substrate is preferably in the range of 0.5 mm to 2 mm. Thickness of the (meth)acrylic resin sheet is preferably in the range of 0.03 mm to 0.2 mm.

The functional layer in the (meth)acrylic resin laminated article and composite sheet is preferably a layer having at least one function selected from anti-reflection function, anti-glare function, hard coat function, anti-static function, and anti-soiling function.

When the (meth)acrylic resin laminated article and composite sheet are allowed to stand for 24 hours in an environment with 50° C. and relative humidity of 90% and for 5 hours in an environment with 23° C. and relative humidity of 50%, it is preferable that the droop ratio is 0.2% or less, and the remaining ratio of a functional layer after performing a cross-cut peeling test based on JIS K 5600-5-6 is 90% or more.

The (meth)acrylic resin laminated article having functional layers like an anti-reflection function layer, an anti-glare function layer, a hard coat function layer, an anti-static function layer, and an anti-soiling function layer formed on a surface of the (meth)acrylic resin sheet according to an embodiment of the present invention and the composite sheet containing the article are preferred as a front panel of a display like an image display member used either inside or outside buildings, a cellular phone, a touch panel display, a solar cell protecting panel, a portable information terminal, or a notebook type PC.

Hereinbelow, preferred embodiments of the present invention are further described.

<Monomer (a) Unit>

The monomer (a) constituting the monomer (a) unit is an acrylic acid ester having a hydrocarbon group with 1 to 11 carbon atoms and one ethylenically unsaturated bond in the molecule.

Specific examples of the monomer (a) include the following monomers.

Acrylic acid esters such as methyl acrylate, ethyl acrylate, isopropyl acrylate, t-butyl acrylate, i-butyl acrylate, n-butyl acrylate, cyclohexyl acrylate, bornyl acrylate, norbornyl acrylate, isobornyl acrylate, adamantyl acrylate, dimethyladamantyl acrylate, methylcyclohexyl acrylate, norbornylmethyl acrylate, mentyl acrylate, pentyl acrylate, dicyclopentanyl acrylate, dicyclopentenyl acrylate, dicyclopentenyloxyethyl acrylate, cyclodecyl acrylate, 4-t-butylcyclohexyl acrylate, or trimethylcyclohexyl acrylate.

<Monomer (b) Unit>

The monomer (b) constituting the monomer (b) unit is a monomer unit having two or more ethylenically unsaturated bonds in the molecule.

Specific examples of the monomer (b) include the following monomers.

Alkane diol di(meth)acrylate such as ethylene glycol di(meth)acrylate, 1,2-propylene glycol di(meth)acrylate, 1,3-butylene glycol di(meth)acrylate, 1,6-hexane diol di(meth)acrylate, or neopentyl glycol di(meth)acrylate; polyoxyalkylene glycol di(meth)acrylate such as diethylene glycol di(meth)acrylate, dipropylene glycol di(meth)acrylate, triethylene glycol di(meth)acrylate, tetraethylene glycol di(meth)acrylate, or polyethylene glycol di(meth)acrylate; a polyfunctional polymerizable compound having two or more ethylenically unsaturated bonds in the molecule like divinyl benzene; and an unsaturated polyester prepolymer derived from at least one polyhydric carboxylic acid containing ethylenically unsaturated polycarboxylic acid and at least one diol.

Among them, from the viewpoint of heat resistance of the (meth)acrylic resin sheet of the present invention, alkane diol di(meth)acrylate is preferable.

Meanwhile, as described herein, the “(meth)acrylate” means at least one selected from “acrylate” and “methacrylate”, the “(meth)acrylic” means at least one selected from “acrylic” and “methacrylic”, and the “(meth)acryloyloxy” means at least one selected from “acryloyloxy” and “methacryloyloxy”.

<Monomer (c) Unit>

The monomer (c) constituting the monomer (c) unit is a (meth)acrylic acid ester other than the monomer (a) and the monomer (b).

From the viewpoint of having a low water absorbing property of the (meth)acrylic polymer (A), examples of the monomer (c) include the one containing a methyl methacrylate unit (the monomer (c1) unit), the monomer (c2) unit having alicyclic hydrocarbon group with 6 to 20 carbon atoms, and the monomer (c3) unit having hydrocarbon group with 3 to 10 carbon atoms.

Specific examples of the monomer (c2) constituting the monomer (c2) unit include the following monomers.

Methacrylic acid esters such as cyclohexyl methacrylate, bornyl methacrylate, norbornyl, isobornyl methacrylate, adamantyl methacrylate, dimethyladamantyl methyl methacrylate, cyclohexyl methacrylate, norbornylmethyl methacrylate, dicyclopentenyl methacrylate, dicyclopentenyloxyethyl methacrylate, cyclodecyl methacrylate, 4-t-butylcyclohexyl methacrylate, dicyclopentanyl methacrylate, trimethylcyclohexyl methacrylate, mentyl methacrylate, or phenethyl methacrylate. Among them, from the viewpoint of having low water absorbing property and high heat resistance, isobornyl methacrylate is preferable.

Specific examples of the monomer (c3) constituting the monomer (c3) unit include the following monomers.

Methacrylic acid esters such as isopropyl methacrylate, t-butyl methacrylate, i-butyl methacrylate, or n-butyl methacrylate ester. Among them, from the viewpoint of having low water absorbing property and high heat resistance, t-butyl methacrylate is preferable.

<(Meth)Acrylic Polymer (A)>

The (meth)acrylic polymer (A) according to an embodiment of the present invention is a copolymer which contains 4.5 to 7.5% by mass of the acrylic acid ester (a) unit, 0.3 to 3.2% by mass of the monomer (b) unit, and 89.3 to 95.2% by mass of the monomer (c) unit.

By having the content of the monomer (a) unit at 4.5% by mass or more in the (meth)acrylic polymer (A), the adhesiveness between the functional layer described below and the (meth)acrylic polymer (A) can be improved. By having the content of the monomer (a) unit at 7.5% by mass or less in the (meth)acrylic polymer (A), the heat resistance of the (meth)acrylic polymer (A) can be improved, the water absorbing property of the (meth)acrylic polymer (A) can be lowered, and as a result, drooping of the (meth)acrylic resin laminated article and composite sheet using the (meth)acrylic polymer (A) can be suppressed. The lower limit of the content of the monomer (a) unit is preferably 4.6% by mass or more, and more preferably 5.0% by mass or more. Furthermore, the upper limit of the monomer (a) unit is preferably 7.1% by mass or less, and preferably 7.0% by mass or less.

By having the content of the monomer (b) unit at 0.3% by mass or more in the (meth)acrylic polymer (A), the heat resistance of the (meth)acrylic polymer (A) can be improved and the water absorbing property of the (meth)acrylic polymer (A) can be lowered. As a result, drooping of the (meth)acrylic resin laminated article and composite sheet using the (meth)acrylic polymer (A) can be suppressed. By having the content of the monomer (b) unit at 3.2% by mass or less, the adhesiveness between the functional layer and the (meth)acrylic polymer (A) can be improved. The lower limit of the monomer (b) unit is preferably 0.4% by mass or more, and more preferably 0.5% by mass or more. Furthermore, the upper limit of the monomer (b) unit is preferably 3.1% by mass or less, and preferably 3.0% by mass or less.

When the total amount of the monomer (a), (b) and (c) units is 100% by mass, content of the monomer (c) unit corresponds to the ratio of the remainings excluding the total amount of the monomer (a) unit and the monomer (b) unit. When the content of the monomer (a) unit is in the range of 4.5 to 7.5% by mass and the content of the monomer (b) unit is in the range of 0.3 to 3.2% by mass, the content of the monomer (c) unit can be set in the range of 89.3 to 95.2% by mass. When the content of the monomer (a) unit is in the range of 4.6 to 7.1% by mass and the content of the monomer (b) unit is in the range of 0.4 to 3.1% by mass, the content of the monomer (c) unit can be set in the range of 89.8 to 95.0% by mass. When the content of the monomer (a) unit is in the range of 5.0 to 7.0% by mass and the content of the monomer (b) unit is in the range of 0.5 to 3.0% by mass, the content of the monomer (c) unit can be set in the range of 90.0 to 94.5% by mass.

When the monomer the monomer (c) unit in the (meth)acrylic polymer (A) contains the monomer (c1) unit, the monomer (c2) unit, and the monomer (c3) unit, content of the monomer (c1) unit, the monomer (c2) unit, and the monomer (c3) unit in the (meth)acrylic polymer (A) is preferably the amount described below.

Content of the monomer (c1) unit in the (meth)acrylic polymer (A) is preferably 65 to 77% by mass. By having the content of the monomer (c1) unit at 65% by mass or more in the (meth)acrylic polymer (A), the transparency of the (meth)acrylic resin sheet tends to improve. By having the content of the monomer (c1) unit at 77% by mass or less, warpage of the (meth)acrylic resin sheet tends to improve as the water absorbing property of the (meth)acrylic polymer (A) is suppressed. The lower limit of the monomer (c1) unit is preferably 67% by mass or more, and more preferably 69% by mass or more. Furthermore, the upper limit of the monomer (c1) unit is preferably 75% by mass or less, and more preferably 74% by mass or less.

Content of the monomer (c2) unit in the (meth)acrylic polymer (A) is preferably 10 to 20% by mass. By having the content of the monomer (c2) unit at 10% by mass or more in the (meth)acrylic polymer (A), warpage of the (meth)acrylic resin sheet tends to improve as the water absorbing property of the (meth)acrylic polymer (A) is suppressed. By having the content of the monomer (c2) unit at 20% by mass or less, the strength of the (meth)acrylic polymer (A) tends to improve. The lower limit of the monomer (c2) unit is preferably 11% by mass or more, and more preferably 12% by mass or more. Furthermore, the upper limit of the monomer (c2) unit is preferably 19% by mass or less, and more preferably 18% by mass or less.

Content of the monomer (c3) unit in the (meth)acrylic polymer (A) is preferably 3 to 7% by mass. By having the content of the monomer (c3) unit at 3% by mass or more in the (meth)acrylic polymer (A), the transparency of the (meth)acrylic polymer (A) tends to improve. By having the content of the monomer (c3) unit at 7% by mass or less, the strength of the (meth)acrylic polymer (A) tends to improve. The lower limit of the monomer (c3) unit is preferably 4% by mass or more. Furthermore, the upper limit of the monomer (c3) unit is preferably 6% by mass or less.

Examples of the shape of the (meth)acrylic polymer (A) include powder and pellet.

Examples of the method for producing the (meth)acrylic polymer (A) include bulk polymerization, solution polymerization, emulsion polymerization, and suspension polymerization. Among them, from the viewpoint of cost for producing the (meth)acrylic polymer (A), load on an environment caused by use of a solvent, and productivity, the bulk polymerization is preferable.

As a method for producing powder of the (meth)acrylic polymer (A), a method of polymerizing a monomer mixture dispersed in water by using a dispersion stabilizer and performing washing and dehydration treatment and vacuum drying for obtaining powder like the method described in JP 2006-193647 A can be mentioned. Furthermore, as a method for producing pellets of the (meth)acrylic polymer (A), there is a method of obtaining a pellet by extruding the powder which is obtained by the above method, or a method of performing bulk polymerization of a monomer mixture in a reactor and extruding it under separation and removal of unreacted monomers as described in JP 2000-26507 A, for example.

Examples of the polymerization method which can be used include a known method like radical polymerization and anion polymerization.

Hereinbelow, conditions for radical polymerization are described.

Examples of a radical polymerization initiator include the followings.

An azo-based polymerization initiator such as 2,2′-azobis(4-methoxy-2,4-dimethylvaleronitrile), 2,2′-azobissobutyronitrile, or 2,2′-azobis-(2,4-dimethylvaleronitrile); and organic peroxide-based polymerization initiator such as lauroyl peroxide, diisopropyl peroxydicarbonate, benzoyl peroxide, bis(4-t-butylcyclohexyl)peroxy dicarbonate, or t-butyl peroxyneo decanoate t-hexylperoxy pivalate.

They may be used either singly or in combination of two or more types.

The addition amount of the radical polymerization initiator is, relative to 100 parts by mass of the total amount of raw material monomers for obtaining the (meth)acrylic polymer (A), preferably 0.01 to 1 part by mass.

Polymerization temperature is preferably 40° C. or higher and more preferably 50° C. or higher. The polymerization temperature is also preferably 180° C. or lower and more preferably 150° C. or lower.

Polymerization time is suitably determined according to progress of the polymerization.

If necessary, various additives like a chain transfer agent, an anti-oxidant, a stabilizer like UV absorbing agent, a flame retardant, a dye, a pigment, and a releasing agent can be added during the polymerization.

The addition amount of the chain transfer agent is, relative to 100 parts by mass of the (meth)acrylic polymer (A), preferably 0.001 to 0.015 part by mass. When the addition amount of the chain transfer agent is 0.001 parts by mass or more, the load droop temperature of the (meth)acrylic polymer (A) tends to become 103° C. or lower if the measurement is made according to the edgewise method of JIS K 7191-1, and the adhesiveness between the functional layer and (meth)acrylic polymer (A) tends to improve. Furthermore, when the addition amount of the chain transfer agent is 0.015 part by mass or less, heat resistance of the (meth)acrylic polymer (A) tends to improve.

Examples of the chain transfer agent include a compound having —SH group at terminal such as terpinolene, α-methylstyrene dimer, n-dodecylmercaptan, 1,2-ethane dithiol, or 1,10-dimethylcaptodecane; a compound having —OH group of polyhydric alcohol substituted with at least two —SH groups such as triethylene glycol dimercaptan, 1,4-dimercapto-2,3-butane diol, or 2,3-dimercapto-1-propanol; a compound having at least one of —SH group, —OH group, and COOH group in the molecule such as thioglycolic acid, 2-mercaptopropionic acid, 3-mercaptopropionic acid, thioglycerol, or thioglycol; an ester compound of thioglycolic acid such as ethylene glycol dithioglycolate, trimethylolpropane tris(β-thiopropionate), trimethylolpropane tris(thioglycolate), pentaerythritol tetrakis(β-thiopropionate), or pentaerythritol tetrakis(thioglycolate), and polyhydric alcohols such as 2-mercaptopropionic acid or 3-mercaptopropionic acid; and 1,5-dimercapto-3-thiapentane.

<(Meth)Acrylic Resin Composition>

The (meth)acrylic resin composition according to an embodiment of the present invention contains the (meth)acrylic polymer (A) and olefin-alkyl(meth)acrylate copolymer (B) (hereinbelow, suitably referred to as “the copolymer (B)”).

The copolymer (B) is a copolymer containing an olefin unit and an alkyl(meth)acrylate unit.

Examples of the olefin as a raw material of an olefin unit for constituting the copolymer (B) include ethylene, propylene, isoprene and butadiene. The olefin unit may be an olefin unit of one kind or an olefin unit of two or more kinds.

Furthermore, examples of the alkyl(meth)acrylate unit as a raw material of the alkyl(meth)acrylate unit for constituting the copolymer (B) include methyl(meth)acrylate, ethyl(meth)acrylate, isopropyl(meth)acrylate, t-butyl(meth)acrylate, i-butyl(meth)acrylate, n-butyl(meth)acrylate, cyclohexyl(meth)acrylate, bornyl(meth)acrylate, norbornyl(meth)acrylate, isobornyl(meth)acrylate, adamantyl(meth)acrylate, dimethyladamantyl(meth)acrylate, methylcyclohexyl(meth)acrylate, norbornylmethyl(meth)acrylate, mentyl(meth)acrylate, pentyl(meth)acrylate, dicyclopentanyl(meth)acrylate, dicyclopentenyl(meth)acrylate, dicyclopentenyloxyethyl(meth)acrylate, cyclodecyl(meth)acrylate, 4-t-butylcyclohexyl(meth)acrylate, and trimethylcyclohexyl(meth)acrylate.

From the viewpoint of the transparency and impact resistance of a (meth)acrylic resin sheet which is formed by using the (meth)acrylic resin composition, the copolymer (B) is preferably the ethylene-alkyl(meth)acrylate copolymer (B-1), more preferably the ethylene-alkyl acrylate copolymer (B-2), and even more preferably an ethylene-methyl acrylate copolymer. Furthermore, the copolymer can be a copolymer with acid anhydride monomer such as maleic anhydride or itaconic anhydride (a copolymer further comprising a unit derived from acid anhydride monomer). Furthermore, the copolymer can be either a random copolymer or a block copolymer.

From the viewpoint of the solubility of the copolymer (B) in a monomer mixture and transparency of the (meth)acrylic resin sheet or (meth)acrylic resin laminated article to be formed, content of the alkyl(meth)acrylate unit in the copolymer (B) is preferably 15% by mass or more. Furthermore, the content is, from the viewpoint of the transparency and impact resistance of the (meth)acrylic resin sheet or (meth)acrylic resin laminated article, preferably 40% by mass or less. When the ethylene-alkyl acrylate copolymer (B-2) is used as the copolymer (B), in particular, the alkyl acrylate unit is preferably contained at 15 to 40% by mass in the ethylene-alkyl acrylate copolymer. When the alkyl acrylate unit is contained at 15% by mass or more, there is a tendency that the copolymer (B) has good solubility for the monomer mixture and the transparency of the (meth)acrylic resin sheet or (meth)acrylic resin laminated article is improved. Furthermore, when the alkyl acrylate unit is contained at 40% by mass or less, there is a tendency that the transparency and impact resistance of the meth)acrylic resin sheet or (meth)acrylic resin laminated article are improved.

Content of the copolymer (B) in the (meth)acrylic resin sheet and content of the copolymer (B) in the (meth)acrylic resin composition for forming the (meth)acrylic resin composition are, when the (meth)acrylic resin sheet or the (meth)acrylic resin laminated article containing the sheet is used as a protective panel or a front panel of a display, in particular, preferably 0.002 to 0.7 part by mass, more preferably 0.005 to 0.5 part by mass, even more preferably 0.01 to 0.5 part by mass, and particularly preferably 0.01 to 0.1 part by mass relative to 100 parts by mass of the (meth)acrylic polymer (A). When content of the copolymer (B) is 0.002 part by mass or more, the impact resistance of the (meth)acrylic resin sheet or the (meth)acrylic resin laminated article containing the sheet can be improved more, and when it is 0.7 part by mass or less, the transparency of the (meth)acrylic resin sheet or the (meth)acrylic resin laminated article containing the sheet can be improved more. Furthermore, for use in a light guide plate, content of the copolymer (B) is preferably 0.005 part by mass or less.

According to an embodiment of the present invention, the compound (C) represented by the following formula (1) can be contained in the (meth)acrylic polymer (A) depending on the purpose.

[Chem. 1]

R₁³X (1)

(in the formula (1), R₁ is an alkyl group having 4 to 8 carbon atoms, a phenyl group, or a phenyl group with a substituent group, and X represents phosphorus).

Examples of the compound (C) include triphenylphosphine, tri n-octylphosphine, tri n-butylphosphine, tri(1,3,5-trimethylphenyl)phosphine, and tri(1,3,5-trimethoxyphenyl)phosphine. Examples of the substituent group on a phenyl group include an alkyl group or an alkoxy group with 1 to 5 carbon atoms.

The content of the compound (C) in the (meth)acrylic resin sheet is preferably 0.01 to 0.05 part by mass relative to 100 parts by mass of the (meth)acrylic polymer (A). When the content of the compound (C) is 0.01 part by mass or more, the adhesiveness between the (meth)acrylic resin sheet or (meth)acrylic resin laminated article and a functional layer tends to improve. Furthermore, when it is 0.05 part by mass or less, the light resistance of the (meth)acrylic resin sheet or (meth)acrylic resin laminated article tends to improve.

According to an embodiment of the present invention, the releasing agent (D) for releasing the (meth)acrylic polymer (A) from a mold can be contained, depending on the purpose. Examples of the releasing agent (D) include an organic salt, and from the viewpoint of less contamination of a mold, it is preferably sodium dioctylsulfosuccinate (AOT) (d-1).

Furthermore, the releasing agent (D) may contain the phosphoric acid ester compound (d-2) which is represented by the following formula (2).

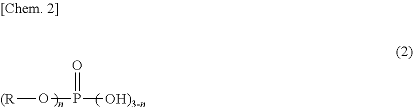

(in the formula (2), n represents an integer of from 1 to 3, and R represents an alkyl group with 1 to 4 carbon atoms).

Among the phosphoric acid ester compound (d-2), from the viewpoint of having good release of the (meth)acrylic resin sheet from a mold, a phosphoric acid ester compound having 4 or 2 carbon atoms in the formula (2) is preferable.

Content of the releasing agent (D) in the (meth)acrylic resin sheet is preferably 0.005 to 1.0 part by mass, more preferably 0.02 to 0.5 part by mass, and even more preferably 0.04 to 0.3 part by mass relative to 100 parts by mass of the (meth)acrylic polymer (A). When the content of the releasing agent (D) is 0.005 part by mass or more, the release property of the (meth)acrylic resin sheet from a mold tends to improve. Furthermore, when it is 1.0 part by mass or less, there is a tendency that mold contamination is suppressed so that a (meth)acrylic resin sheet with excellent outer appearance can be obtained.

<(Meth)Acrylic Resin Sheet>

The (meth)acrylic resin sheet according to an embodiment of the present invention is a sheet obtained from the (meth)acrylic polymer (A) or (meth)acrylic resin composition.

Thickness of the (meth)acrylic resin sheet is preferably 0.2 mm to 15 mm.

Examples of the method for producing the (meth)acrylic resin sheet include a cast polymerization, extrusion molding, and injection molding. Among them, from the viewpoint of obtaining a transparent resin sheet, a cast polymerization is preferable for use like optical application requiring transparency, in particular.

The cast polymerization is a method in which two pieces of a plate that are oppositely disposed at pre-determined space and a mold formed of a sealing material that is disposed around periphery of the plate are used, a polymerizable material for obtaining a (meth)acrylic resin sheet is injected to the mold to form a sheet, and the obtained sheet is released from the mold.

The mold for cast polymerization is not particularly limited, and a commonly used mold can be used. Examples of a mold for obtaining plate-like resin molded article include a mold for cell casting and a mold for continuous casting.

Examples of the mold for cell casing include a mold in which two pieces of a plate like inorganic glass plate, chrome-plated metal plate, and stainless steel plate are oppositely disposed at pre-determined space, a gasket is arranged around the periphery, and a sealed space is created between the plates and gasket.

Examples of the mold for continuous casting include a mold in which a sealed space is created between a surface facing one pair of endless belts running at the same speed in the same direction and a gasket, which is present on the two lateral sides, running at the same speed as the endless belt.

The polymerizable material to be injected to a mold includes the following raw material composition (1), the raw material composition (2), or the raw material composition (3), for example. Meanwhile, to the raw material composition (1), the raw material composition (2), or the raw material composition (3), the copolymer (B), the compound (C), or the releasing agent (D) can be added.

Raw material composition (1): a composition containing the monomer mixture (1) having the monomer (a), the monomer (b), and the monomer (c), raw material composition (2): a composition containing the syrup (1) which is obtained by polymerizing part of the monomer mixture (1) having the monomer (a), the monomer (b), and the monomer (c), and raw material composition (3): a composition containing the syrup (2) which is obtained by dissolving a polymerized product obtained by polymerizing the first monomer mixture (2) containing the monomer (a), the monomer (b), and the monomer (c) in the second monomer mixture (2′) containing the monomer (a), the monomer (b), and the monomer (c).

Herein, the first monomer mixture (2) and the second monomer mixture (2′) can have the same composition or a different composition as long as the composition of the (meth)acrylic polymer (A) to be obtained has a pre-determined composition.

The above syrup (1) and the syrup (2) are a viscous liquid having a polymer dissolved in monomer.

Content of the polymer in the syrup (1) or the syrup (2) is preferably 5 to 45% by mass. When the content of the polymer in the syrup is 5% by mass or more, there is a tendency that the polymerization time can be shortened during cast polymerization and a defective outer appearance does not easily occur on a surface of the (meth)acrylic resin sheet. Furthermore, when the content of the polymer in the syrup is 45% by mass or less, handling property of the syrup tends to improve due to appropriate syrup viscosity. In order to shorten the syrup polymerization time and inhibit an occurrence of defective appearance of a (meth)acrylic resin sheet to be obtained, it is preferable that the syrup polymerization is as high as possible. On the other hand, considering the handling property of syrup or dispersion property of additives, it is preferable that the syrup polymerization is as low as possible. From these points of view, the polymer content in the syrup is preferably 5 to 45% by mass, and more preferably 10 to 40% by mass.

As a method for adjusting the polymer content in the syrup to a range of 5 to 45% by mass, there is a method in which a pre-determined amount of a composition containing the monomer mixture (1) or the monomer mixture (2) is weighed and added to a reactor equipped with a condenser, a thermometer, and a stirrer followed by stirring under heating, a polymerization initiator is added, and polymerization is allowed to occur by maintaining them at pre-determined temperature followed by cooling.

In the obtained syrup, a polymerization inhibitor may be added, if necessary, in order to avoid coloration or natural curing.

Specific examples of the polymerization inhibitor include hydroquinone, hydroquinone monomethyl ether, 2,6-di-t-butyl-4-methylphenol, and 2,4-dimethyl-6-t-butylphenol. It may be used either singly or in combination of two or more types.

Examples of the polymerization mode for cast polymerization include radical polymerization and anion polymerization. Among them, from the availability of raw materials, easy management of production conditions, and simple manufacture using common facilities, the radical polymerization is preferable.

When the radical polymerization is employed, the same radical polymerization initiator or various additive as those for obtaining the (meth)acrylic polymer (A) can be added to a polymerizable material. Addition amount of the radical polymerization initiator is, relative to 100 parts by mass of the total monomer amount, preferably 0.01 to 1 part by mass.

The polymerization temperature of the polymerizable material is preferably 40° C. or higher, and more preferably 50° C. or higher. Furthermore, the polymerization temperature of the polymerizable material is preferably 180° C. or lower, and more preferably 150° C. or lower. The polymerization temperature is suitably determined depending on the progress of polymerization curing.

When the (meth)acrylic resin sheet according to an embodiment of the present invention is prepared by cast polymerization, as a polymerization material, the raw material composition (1) and (2) are preferable from the viewpoint of the impact resistance and transparency of the (meth)acrylic resin sheet. The raw material composition (1) is more preferable. Furthermore, from the viewpoint of productivity of the (meth)acrylic resin sheet, the raw material composition (1) and (2) are preferable and the raw material composition (2) is more preferable.

<(Meth)Acrylic Resin Laminated Article>

The (meth)acrylic resin laminated article according to an embodiment of the present invention is a laminate having a functional layer, which is described below, laminated on at least one surface of the (meth)acrylic resin sheet.

The droop ratio of the (meth)acrylic resin laminated article is preferably 0.2% or less. When the droop ratio is 0.2% or less, there is a tendency that appearance defect like interference shape can be inhibited without having the (meth)acrylic resin laminated article in contact with an image display side.

In the present invention, the droop ratio indicates the value obtained by the following formula (ratio of the droop amount (a) relative to the long side (b) of a sheet test sample before droop test) after performing a droop test (after keeping for 24 hours in high temperature and high humidity environment of 50° C. and relative humidity of 90%, it is again kept for 5 hours in a typical environment of 23° C. and relative humidity of 50%), and obtaining the displacement amount (droop amount: a) in vertical direction at center part of the sheet test sample relative to the end part of the sheet test sample (ends of the four sides of a fixed test sample).

Droop ratio (%)=Droop amount (a)+Long side of test sample (b)×100

When a cross cut peeling test is performed based on JIS K 5600-5-6, it is preferable that the (meth)acrylic resin sheet and functional layer of (meth)acrylic resin laminated article have adhesiveness such that the remaining ratio of the functional layer is 90% or more. When the remaining ratio of the functional layer is 90% or more, there is a tendency that a problem like poor image recognizablity accompanied with film release can be suppressed when it is used for a protective panel of an image display device.

It is preferable that the (meth)acrylic resin laminated article has JIS K 7136-based haze of 0.5% or less and 50% impact fracture height of 300 mm or more according to the falling ball test based on JIS K 7211.

<Functional Layer>

Examples of the functional layer include a layer which has at least one of the functions including abrasion resistance (hard coat function), anti-reflecting property, anti-glare property, anti-soling property (contamination preventing function), anti-static property, anti-scattering property, tacky property, adhesive property, and soft property. The functional layer is preferably a layer which has at least one function selected from anti-reflection function, anti-glare function, hard coat function, anti-static function, and anti-soiling function. Furthermore, if necessary, the functional layer can be prepared as a monolayer or a multilayer with two or more layers. When it is prepared as a multilayer with two or more layers, a functional layer with two or more functions can be obtained.

The functional layer can be a layer of a cured product of a curable composition, for example. The layer of a cured product has a hard coat function, and thus it can have enhanced abrasion resistance.

Examples of the curable composition include a thermally curable composition and an active energy ray curable composition.

As the thermally curable composition, a radical polymerizable composition like vinyl monomer and a condensation type curable composition like alkoxysilane and alkylalkoxysilane can be mentioned. It can be used either singly or in combination of two or more types.

Examples of the active energy ray for the case of using an active energy ray curable composition include electron beam, radioactive ray, and ultraviolet ray. The active energy ray curable composition may be used either singly or in combination of two or more types.

As the curable composition, from the viewpoint of the productivity and physical properties of the (meth)acrylic resin laminated article, an ultraviolet ray curable composition is preferable. Examples of the ultraviolet ray curable composition include a composition which contains a compound having at least two (meth)acryloyloxy groups in the molecule and a photoinitiator (ultraviolet ray polymerization initiator).

Examples of the compound having at least two (meth)acryloyloxy groups in the molecule include the same monomer as the monomer (b) and the following compounds: an esterification product obtained from 1 mole of a polyhydric alcohol and at least 2 moles of (meth)acrylic acid or a derivative thereof and an esterification product obtained from a polyhydric alcohol, a polyvalent carboxylic acid or an anhydride thereof, and (meth)acrylic acid or a derivative thereof.

Specific examples of the esterification product obtained from 1 mole of a polyhydric alcohol and at least 2 moles of (meth)acrylic acid or a derivative thereof include the following compounds: poly(meth)acrylates of polyols having functionality of 3 or higher such as trimethylol propane tri(meth)acrylate, trimethylol ethane tri(meth)acrylate, pentaglycerol tri(meth)acrylate, pentaerythritol tri(meth)acrylate, pentaerythritol tetra(meth)acrylate, glycerin tri(meth)acrylate, dipentaerythritol tri(meth)acrylate, dipentaerythritol tetra(meth)acrylate, dipentaerythritol penta(meth)acrylate, dipentaerythritol hexa(meth)acrylate, tripentaerythritol tetra(meth)acrylate, tripentaerythritol penta(meth)acrylate, tripentaerythritol hexa(meth)acrylate, or tripentaerythritol hepta(meth)acrylate.

Further, examples of a combination of a polyhydric alcohol, a polyvalent carboxylic acid or an anhydride thereof, and (meth)acrylic acid or a derivative thereof include the following combinations: malonic acid/trimethylolethane/(meth)acrylic acid, malonic acid/trimethylolpropane/(meth)acrylic acid, malonic acid/glycerine/(meth)acrylic acid, malonic acid/pentaerythritol/(meth)-acrylic acid, succinic acid/trimethylolethane/(meth)acrylic acid, succinic acid/trimethylolpropane/(meth)acrylic acid, succinic acid/glycerine/(meth)acrylic acid, succinic acid/pentaerythritol/(meth)acrylic acid, adipic acid/trimethylolethane/(meth)acrylic acid, adipic acid/trimethylolpropane/(meth)acrylic acid, adipic acid/glycerine/(meth)acrylic acid, adipic acid/pentaerythritol/(meth)acrylic acid, glutaric acid/trimethylolethane/(meth)acrylic acid, glutaric acid/trimethylolpropane/(meth)acrylic acid, glutaric acid/glycerine/(meth)acrylic acid, glutaric acid/pentaerythritol/(meth)acrylic acid, sebacic acid/trimethylolethane/(meth)acrylic acid, sebacic acid/trimethylolpropane/(meth)acrylic acid, sebacic acid/glycerine/(meth)-acrylic acid, sebacic acid/pentaerythritol/(meth)acrylic acid, fumaric acid/trimethylolethane/(meth)acrylic acid, fumaric acid/trimethylolpropane/(meth)acrylic acid, fumaric acid/glycerine/(meth)acrylic acid, fumaric acid/pentaerythritol/(meth)acrylic acid, itaconic acid/trimethylolethane/(meth)acrylic acid, itaconic acid/trimethylolpropane/(meth)acrylic acid, itaconic acid/glycerine/(meth)acrylic acid, itaconic acid/pentaerythritol/(meth)acrylic acid, maleic anhydride/trimethylolethane/(meth)acrylic acid, maleic anhydride/trimethylolpropane/(meth)acrylic acid, maleic anhydride/glycerine/(meth)acrylic acid, and maleic anhydride/pentaerythritol/(meth)acrylic acid.

Other specific examples of the compound having at least two (meth)acryloyloxy groups in the molecule include the following compounds: an urethane(meth)acrylate obtained from the reaction between 1 mole of polyisocyanate obtained by trimerization of a diisocyanate (for example, trimethylolpropane toluylene diisocyanate, hexamethylene diisocyanate, tolylene diisocyanate, diphenylmethane diisocyanate, xylene diisocyanate, 4,4′-methylene-bis(cyclohexyl isocyanate), isophorone diisocyanate, or trimethyl hexamethylene diisocyanate) with at least 3 moles of an acrylic monomer having an active hydrogen (for example, 2-hydroxyethyl(meth)acrylate, 2-hydroxypropyl(meth)acrylate, 2-hydroxy-3-methoxypropyl(meth)acrylate, N-methylol(meth)acrylamide, N-hydroxy(meth)acrylamide, 1,2,3-propanetriol-1,3-di(meth)acrylate, and 3-acryloyloxy-2-hydroxypropyl(meth)acrylate); poly [(meth)acryloyloxyethylene]isocyanurate such as di(meth)acrylate or tri(meth)acrylate of tris(2-hydroxyethyl)isocyanuric acid; epoxypoly(meth)acrylate; and urethane poly(meth)acrylate.

Specific examples of the photoinitiator used for an ultraviolet ray curable composition include the following compounds: carbonyl compounds such as benzoin, benzoin methyl ether, benzoin ethyl ether, benzoin isopropyl ether, benzoin isobutyl ether, acetoin, butyroin, toluoin, benzyl, benzophenone, p-methoxybenzophenone, 2,2-diethoxyacetophenone, α,α-dimethoxy-α-phenylacetophenone, methyl phenylglyoxylate, ethyl phenylglyoxylate, 4,4′-bis(dimethylamino)benzophenone, 1-hydroxy-cyclohexyl-phenyl-ketone, or 2-hydroxy-2-methyl-1-phenylpropane-1-on; sulfur compounds such as tetramethylthiuram monosulfide and tetramethylthiuram disulfide; and phosphorus compounds such as 2,4,6-trimethylbenzoyl diphenylphosphine oxide, bis(2,4,6-trimethylbenzoyl)-phenylphosphine oxide, and benzoyl diethoxyphosphine oxide.

Thickness of the functional layer is, from the viewpoint of surface hardness and outer appearance of the (meth)acrylic resin laminated article, preferably 1 to 100 μm, and more preferably 1 to 30 μm when the functional layer is a hard coat layer.

Examples of the method for applying a curable composition on a surface of the (meth)acrylic resin sheet include a flow casting method, a gravure coating method, a reverse gravure coating method, a vacuum slot die coating method, a roller coating method, a bar coating method, a spray coating method, an air knife coating method, a spin coating method, a flow coating method, a curtain coating method, a film covering method (for example, UV laminate transfer method), and a dipping method. From the viewpoint of having good surface smoothness due to fewer defects caused by foreign materials in a coating film, the film covering method is preferable.

As a method for obtaining the (meth)acrylic resin laminated article by applying a curable composition according to a film covering method, a production method having steps of forming a film laminate by adhering a cover film on a (meth)acrylic resin sheet via a curable composition (step for forming a laminate before curing), curing the curable composition to give a functional layer (step for forming a laminate after curing), and peeling off the cover film to obtain a (meth)acrylic resin laminated article can be mentioned. With regard to the step for forming a laminate before curing, it is possible that a curable composition is applied on a single surface of a (meth)acrylic resin sheet and a cover film is adhered onto the coated surface to form a film laminate. It is also possible to obtain a (meth)acrylic resin laminated article by forming in advance a releasable functional layer on a cover film surface, adhering the cover film with functional layer onto a (meth)acrylic resin sheet, and transferring the functional layer onto the (meth)acrylic resin sheet side by peeling off the cover film. According to such method, a (meth)acrylic resin laminated article with various functions can be produced.

As for the cover film, an active energy ray transmissive film is used, and a known film can be used. In addition, it is sufficient for a functional layer to be a film with release property. However, if the release property is insufficient, a release layer may be formed on a surface of the cover film.

Examples of the active energy ray transmissive film include synthetic resin films such as polyethylene terephthalate film, polypropylene film, polycarbonate film, polystyrene film, polyamide film, polyamide-imide film, polyethylene film, and polyvinylchloride film; cellulose films such as cellulose acetate film; film-like materials such as cellophane paper, Glassine paper, western paper, and Japanese paper; and composite films thereof or composite sheets thereof. In addition, these films or sheets on which release layers are provided can be mentioned.

Thickness of the active energy ray transmissive film is preferably 4 to 500 μm. As the thickness of the active energy ray transmissive film is 4 to 500 μm, a transfer film free of crease or crack can be obtained. The lower limit of the thickness of the active energy ray transmissive film is preferably 4 μm or more, more preferably 12 μm or more, and even more preferably 30 μm or more. Furthermore, the upper limit of the thickness of the active energy ray transmissive film is preferably 500 μm or less, more preferably 150 μm or less, and even more preferably 120 μm or less.

As a releasing agent for forming a release layer, a releasing agent like known polymer and wax can be suitably used.

As a method for forming the release layer, a method in which a coating material obtained by dissolving at least one of a paraffin wax; a resin like acrylic based, urethane based, silicone based, melamine based, urea based, urea-melamine based, cellulose based, or benzoguanamine based resin; and a surface active agent in an organic solvent or water is coated and dried (in case of a curable coating film like thermally curable resin, ultraviolet ray curable resin, electron beam curable resin, radiation curable resin, or the like) on a cover film by a common printing method like gravure printing method, screen printing method, and off-set printing method can be mentioned.

Thickness of the release layer is preferably about 0.1 to 3 μm. If the release layer is excessively thin, peeling may be difficult to achieve. On the other hand, if the release layer is excessively thick, it may be peeled off too easily so that each layer on a cover film may be dissociated before transfer.

(Anti-Reflection Layer)

When an anti-reflection layer having anti-reflection function is laminated as a functional layer, the anti-reflection may be composed of any materials as long as it can suppress the reflected light normally to the extent of 20% or less of the incident light on the surface of the (meth)acrylic resin laminate, preferably 10% or less, and more preferably 5% or less. In order to give such a function, for example, a method of forming a laminate structure from two or more layers each having a different refractive index can be mentioned.

In the case when the laminate structure consists of two layers each having a different refractive index, regarding the refractive index of each layer, it is preferable to have a laminate structure in which an outermost surface facing to the air is a low refractive index layer having a refractive index of about 1.3 to 1.5 and a high refractive index layer located on the (meth)acrylic resin sheet side has a refractive index of 1.6 to 2.0. When the refractive indices are in those ranges, the reflected light of the incident light can be sufficiently suppressed.

The thicknesses of the low refractive index layer and the high refractive index layer are not particularly limited, but each of them is preferably 50 nm or more, and more preferably 70 nm or more. Furthermore, it is preferably 200 nm or less, and more preferably 150 nm or less. When the thickness of each layer is in this range, the reflected light having a recognized wavelength can be sufficiently suppressed.

The low refractive index layer preferably has a refractive index of about 1.3 to 1.5. For example, a material which is composed of a curable compound to be cured by condensation polymerization such as alkoxysilane or alkylalkoxysilane and mainly contains siloxane bond can be mentioned as a low refractive index layer. Specific examples thereof include materials formed of a siloxane resin in which a part of siloxane bonds is substituted by hydrogen atom, hydroxyl group, unsaturated group, or alkoxyl group.

Examples of the component for forming a low refractive index include a composition which can be cured by an active energy ray including electron beam, radioactive ray, and ultraviolet ray, and a thermally curable composition. They may be used either singly or in combination of two or more compound having curing property.

In addition, it is preferable to add colloidal silica to the component forming a low refractive index from the viewpoint of attaining a further lower refractive index. Colloidal silica is a colloidal solution in which at least one fine particles of porous silica and non-porous silica are dispersed in a dispersion medium. Note that, porous silica is a low-density silica containing air inside, each particle of which is porous or hollow. Porous silica has a refractive index of 1.20 to 1.40, which is lower than that of normal silica, namely, 1.45 to 1.47. Therefore, in the present invention, it is more preferable to use porous silica as colloidal silica in order to lower the refractive index of the low refractive index layer. In addition, it is also possible to use, if necessary, colloidal silica which have been subjected to a surface treatment with a silane coupling agent.

The high refractive index layer preferably has refractive index of about 1.6 to 2.0. As for the high refractive index layer, a metal oxide film obtained by hydrolyzing metal alkoxide followed by condensation can be exemplified.

Examples of the metal alkoxide include those represented by the following formula (3).

[Chem. 3]

M(OR)ₘ (3)

(in the formula (3), M represents a metal, R represents a hydrocarbon group with 1 to 5 carbon atoms, and m represents the atomic valance of the metal M (3 or 4)).

Preferred examples of the metal M include titanium, aluminum, zirconium, and tin, and in particular, titanium is more preferable, from the viewpoint of the refractive index of the high refractive index layer.

Specific examples of the metal alkoxide include titanium methoxide, titanium ethoxide, titanium n-propoxide, titanium isopropoxide, titanium n-butoxide, titanium isobutoxide, aluminum ethoxide, aluminum isopropoxide, aluminum butoxide, aluminum t-butoxide, tin t-butoxide, zirconium ethoxide, zirconium n-propoxide, zirconium isopropoxide, and zirconium n-butoxide.

According to an embodiment of the present invention, it is preferable to disperse fine particles of a metal oxide having a high refractive index, which is at least one of ZrO₂, TiO₂, NbO, ITO, ATO, SbO₂, In₂O₃, SnO₂, and ZnO, in the metal oxide film from the viewpoint of obtaining a higher refractive index of the metal oxide layer.

According to an embodiment of the present invention, it is also possible to use, as a high refractive index layer, the layer obtained by dispersing the fine particles of a metal oxide having a high refractive index in an ultraviolet ray curable composition for forming a hard coat layer followed by curing, in addition to the metal oxide film. In that case, it is possible to use fine particles of a metal oxide having a high refractive index which have been subjected to a surface treatment.

Examples of the method for forming the anti-reflection layer include a flow casting method, a roller coating method, a bar coating method, a spray coating method, an air knife coating method, a spin coating method, a flow coating method, a curtain coating method, a film covering method, and a dipping method.

According to an embodiment of the present invention, it is preferable to form at least one layer of an adhesive layer and a hard coat layer on the (meth)acrylic resin sheet side of the anti-reflection layer. When the adhesive layer is formed, adhesiveness between the anti-reflection layer and (meth)acrylic resin sheet is improved. Further, when the hard coat layer is formed, hardness of the anti-reflective laminate is also improved.

(Anti-Glare Layer)

When an anti-glare layer having an anti-glare function is laminated as a functional layer, reflection of external light can be suppressed by at least one method including a method forming fine irregularities on a surface of an anti-glare layer and a method of having scattered reflection of external light by internal scattering according to addition of light diffusing microparticles in an anti-glare layer. As for the method for forming a functional layer with an anti-glare layer, the following method can be mentioned, for example.

A laminate having an anti-glare layer with fine irregular-shaped surface on a surface of (meth)acrylic resin sheet can be obtained as follows: first, an ultraviolet ray curable composition which form the aforementioned hard coat layer is coated on a film transmissive to the active energy ray and having a desired fine irregularities followed by curing to obtain a film having a hard coat layer formed thereon; then the film is laminated such that the hard coat layer surface is in contact with the surface of the (meth)acrylic resin sheet, and the film transmissive to the active energy ray is peeled off. When a hard coat layer is laminated on a surface of the (meth)acrylic resin sheet, an adhesive may be used, if necessary. Furthermore, for improving the release property between the film transmissive to the active energy ray and a surface of fine irregularities on the hard coat layer, a release agent may be added to the hard coat layer, if necessary.

As the method for producing fine irregularities on a surface of the film transmissive to the active energy ray, there is a method of forming irregularities directly on a surface of a film transmissive to the active energy ray and a method of providing irregularities on a smooth surface of a film transmissive to the active energy ray by coating method.

As for the method of forming irregularities directly on a surface of a film transmissive to the active energy ray, there is a method of kneading particles in a resin for forming a film transmissive to the active energy ray, a method of heating a resin for forming a film transmissive to the active energy ray to the glass transition temperature or higher and then transferring a fine irregular shape on a mold surface by using a mold having fine irregularities on the surface.

As the method for providing irregularities on a surface of smooth film transmissive to the active energy ray by coating method, there is a method of applying an anti-glare coating agent and a method of pouring a curable composition into a gap between a film transmissive to the active energy ray and a mold having fine irregularities followed by curing and releasing from the mold (2P method).

As for the method for producing a mold having a surface with fine irregularities, there is a method of forming fine irregularities by sand blast, chemical etching, lithography, and the like. The mold preferably has a roll shape from the viewpoint of having good productivity.

(Anti-Soling Layer)

When an anti-soling layer having an anti-soiling function is laminated as a functional layer, the function possessed by the anti-soiling layer may be a water repellent property or an oil repellent property, or may be a hydrophilic property or a lipophilic property. However, it preferably has a water repellent property or an oil repellent property from the viewpoint of having easy removal of soils.

As a raw material for forming an anti-soiling layer with a water repellent property or an oil repellent property, an ultraviolet ray curable composition containing a compound having at least two (meth)acryloyloxy groups in the molecule, (meth)acrylate having a fluorine atom, and an ultraviolet ray polymerization initiator is preferable from the viewpoint of productivity.

As a compound having at least two (meth)acryloyloxy groups in the molecule, the aforementioned compound having two (meth)acryloyloxy groups can be used. Furthermore, as an ultraviolet ray polymerization initiator, the aforementioned ultraviolet ray polymerization initiator can be used.

The (meth)acrylate having a fluorine atom is an essential component for exhibiting the water repellent • oil repellent (anti-soiling) performance of a water repellent layer.

As the (meth)acrylate having a fluorine atom, a known (meth)acrylate having a fluorine atom can be used. Examples of a commercially available product of (meth)acrylate having a fluorine atom include “Biscoat 17F” (trade name) as heptadecan fluorodecyl acrylate manufactured by OSAKA ORGANIC CHEMICAL INDUSTRY LTD, “Light acrylate FA-108” (trade name) as perfluorooctyl ethyl acrylate manufactured by KYOEISHA CHEMICAL Co., LTD., and “16-FDA” (trade name) as 1,10-bis(meth)acryloyloxy-2,2,3,3,4,4,5,5,6,6,7,7,8,8,9,9-hexa decafluorodecane manufactured by KYOEISHA CHEMICAL Co., LTD.

Furthermore, as the (meth)acrylate having a fluorine atom, (meth)acrylate having a perfluoropolyether group is preferable from the viewpoint of good water repellent • oil repellent performance of the anti-soiling layer. Examples of a commercially available product of the (meth)acrylate having a perfluoropolyether group include “OPTOOL DAC” (trade name) manufactured by DAIKIN INDUSTRIES, Ltd. and “EXP RS-503” and “EXP RS-751-k” (trade name) manufactured by DIC Corporation.

The (meth)acrylate having a fluorine atom may be used either singly or in a combination of two or more kinds thereof.

The addition amount of the (meth)acrylate having a fluorine atom is preferably 0.1 to 2 parts by mass relative to 100 parts by mass of the compound having at least two (meth)acryloyloxy groups in the molecule. When the amount of the (meth)acrylate having a fluorine atom is 0.1 part by mass or more, sufficient water repellent • oil repellent performance of the anti-soiling layer can be achieved. In addition, when the amount of the (meth)acrylate having a fluorine atom is 2 parts by mass or less, good curability and transparency of the anti-soiling layer can be obtained.

The addition amount of the ultraviolet ray polymerization initiator is preferably 0.1 to 10 parts by mass relative to relative to 100 parts by mass of the compound having at least two (meth)acryloyloxy groups in the molecule.

The thickness of the anti-soiling layer is preferably 0.1 μm or more, and more preferably 1 μm or more. Furthermore, the thickness of the anti-soiling layer is preferably 15 μm or less, and more preferably 10 μm or less. When the thickness is in this range, an anti-soiling layer with sufficient surface hardness and transparency can be obtained and also the film warpage caused by the anti-soiling layer is small, and thus the outer appearance tends to improve.

The (meth)acrylate having a fluorine atom in the ultraviolet ray curable composition described above has a low surface tension and thus tends to gather at the interface with air which has a lower surface tension than at the interface with the film transmissive to the active energy ray which has a relatively high surface tension. Therefore, when the anti-soiling layer is laminated by a transfer method on a surface of the (meth)acrylic resin sheet, the (meth)acrylate having a fluorine atom comes to exist more at the (meth)acrylic resin sheet (A) side (hereinbelow, it is described as “aligned”), and thus the water repellent • oil repellent performance of the anti-soiling layer on the surface layer of a thus obtained resin laminate tends to become insufficient. In order to prevent such tendency and align the (meth)acrylate having a fluorine atom on the side of the film transmissive to the active energy ray, it is preferable to form a coating film having a fluorine atom on the film transmissive to the active energy ray and to form the anti-soiling layer thereon.

The coating film having a fluorine atom is obtained by application of a known fluorine-containing coating material which contains a fluorine-containing compound and an organic solvent on a film followed by evaporation the organic solvent.

As for the fluorine-containing compound, a fluorine-containing compound represented by the following formula (4) is preferable from the viewpoint of forming a coating film having a low surface tension.

[Chem. 4]

Rf—Si—(O—R)₃ (4)

(in the formula (4), formula (I), Rf represents an organic functional group having a fluorine atom and R represents an alkyl group having 1 to 3 carbon atom).

The fluorine-containing compound contained in the fluorine-containing coating material described above is a component for forming a below-described coating film having a low surface tension and excellent water repellent • oil repellent performance on a surface of the film.

Rf is preferably a perfluoroalkyl group or a perfluoropolyether group from the viewpoint of an oil repellent performance and adhesiveness with the film.

The carbon atom number of the perfluoroalkyl group is preferably in the range of 2 to 16.

Preferred structure of the perfluoropolyether group is a group derived from the compound represented by the following formula (5) (a residue of the formula (5) in which H of the terminal OH is removed).

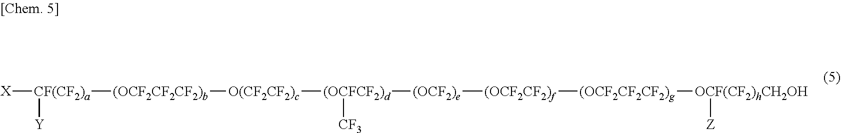

(in the formula, X represents a fluorine atom, Y and Z independently represent a fluorine atom or a trifluoromethyl group, each of a to h is independently an integer, a is an integer of from 1 to 16, c is an integer of from 0 to 5, b, d, e, f and g are an integer from 0 to 200, and h is an integer of from 0 to 16).

In the formula (5), the molecular weight does not become excessively high as long as the numerical value of a to h is not excessively high, and thus the solubility tends to improve. In addition, if the numerical value of a to h is not excessively low, the water repellent property and oil repellent property tend to improve.

The fluorine-containing compound may be used either singly or in a combination of two or more kinds thereof.

From the viewpoint of obtaining a coating film with high water repellent oil repellent performances, the fluorine-containing compound is preferably contained at 0.02 to 0.2% by mass in a fluorine-containing coating material.

As for an organic solvent to be contained in a fluorine-containing coating material, a solvent having excellent compatibility with a fluorine-containing compound can be used. Furthermore, the organic solvent to be contained in a fluorine-containing coating material is used for controlling viscosity and drying speed of a fluorine-containing coating material and thickness of a coating film.

The thickness of the coating film with a fluorine atom is preferably 2 nm or higher, and more preferably 5 nm or higher. Furthermore, the thickness of the coating film with a fluorine atom is preferably 20 nm or lower, and more preferably 10 nm or lower. When the film thickness is within this range, a coating film having good outer appearance and being effective for forming an anti-soiling layer can be obtained.

Examples of the organic solvent include non-fluorine solvents such as hydrocarbon solvents and fluorine-containing solvents, and the fluorine-containing solvents are preferable from the viewpoint of having excellent compatibility with the fluorine-containing compound.

Examples of the non-fluorine solvents include ketones such as methyl ethyl ketone, acetone, and methyl isobutyl ketone; alcohols like monovalent alcohols such as ethanol, 1-propanol, 2-propanol, butanol, and 1-methoxy-2-propanol and polyhydric alcohols such as ethylene glycol, diethylene glycol, and propylene glycol; esters such as ethyl acetate, butyl acetate, and γ-butyrolactone; ethers such as diethylene glycol monomethyl ether, diethylene glycol monomethyl ether acetate, tetrahydrofuran, and 1, 4-dioxane; aromatic hydrocarbons such as toluene and xylene; and amides such as dimethyl formamide, dimethyl acetamide, and N-methylpyrrolidone.

Examples of the fluorine-containing solvent include fluorine-containing alcohols, fluorine-containing ethers, and ditrifluoromethylbenzene.

The organic solvent to be contained in a fluorine-containing coating material can be used either singly or in a combination or two or more kinds thereof.

As for the method of producing the fluorine-containing coating material, any method like a method of suitably controlling the concentration or viscosity by mixing a required amount of a fluorine-containing compound and an organic solvent and a method of using a commercially available product, in which the fluorine-containing compound and the organic solvent have already been mixed, and adding an organic solvent, if necessary, can be employed.

Examples of the commercially available fluorine-containing coating material include “Fluorosurf FG5010” (trade name) manufactured by Fluoro Technology Co., Ltd., “OPTOOL DSX” and “OPTOOL AES-4” (both, trade names) manufactured by Daikin Industries, Ltd., and “NOVEL EGC-1720” (trade name) manufactured by Sumitomo 3M Limited. When these commercially available materials are used, an organic solvent can be properly added so as to control the content of the fluorine-containing compound.

As a method of coating the fluorine-containing coating material on a surface of a film, the same methods as those described for forming an anti-reflection layer described above can be mentioned.

Regarding the method for forming a coating film with a fluorine atom, it can be obtained by application of the fluorine-containing coating material on a film followed by drying treatment by way of evaporation of the organic solvent.

The fluorine-containing coating material has a low surface tension and it is easy for a film surface to repel fluorine-containing coating material at the time of coating, and thus it is preferable to perform film coating by a film covering method. In addition, the fluorine-containing coating material is preferably cured in an anaerobic atmosphere, so that polymerization cannot be inhibited by oxygen and the like from the viewpoint of improving the abrasion resistance of the anti-soiling layer and preventing incorporation of bubbles or dust which causes an unsatisfactory finish.

At the time of performing transfer of an anti-soiling layer, the (meth)acrylate having a fluorine atom, which is contained in the fluorine-containing coating material, tends to easily align at the surface layer on the coating film side of the coat of the fluorine-containing coating material, because the coating film thus obtained has a low surface tension and excellent water repellent • oil repellent performance. As a result, the water repellent • oil repellent property of the anti-soiling layer on the (meth)acrylic resin laminated article to be obtained is improved. The contact angle of the surface of the anti-soiling layer on the (meth)acrylic resin laminated article against water is preferably 100 degrees or more and more preferably 105 degrees or more.

As a method for coating the fluorine-containing coating material containing the (meth)acrylate having a fluorine atom on the coating film of the film transmissive to the active energy ray, which has a coating film with a fluorine atom laminated thereon, the same methods as those described for forming an anti-reflection layer described above can be mentioned.

Examples of the fluorine-containing coating material include those cured by active energy ray such as electron beam, radioactive ray, or ultraviolet ray.

Hereinbelow, one embodiment of the method for producing the (meth)acrylic resin laminated article, which is laminated with an anti-soiling layer by film covering method, is described in detail.

A fluorine-containing coating material is coated on a film transmissive to the active energy ray and dried to form a coating film having a fluorine atom, and then an ultraviolet ray curable composition containing the (meth)acrylate having a fluorine atom is coated on the surface of the coating film having a fluorine atom. Subsequently, an arbitrary surface of a film transmissive to the active energy ray, which is a separate cover film, and the surface of the film transmissive to the active energy ray on which the ultraviolet ray curable composition has been coated are arranged to face each other and pressed with a press roll, and thus a laminate in which the film transmissive to the active energy ray, the coating film having a fluorine atom, the ultraviolet ray curable composition coating film, and the cover film are sequentially laminated in this order is formed. Then, the laminate is irradiated, through the cover film, with ultraviolet rays from the cover film side by use of an active energy ray-irradiation device, and the ultraviolet ray curable composition is cured.

According to this embodiment of the present invention, it is preferable to provide a retention time between the formation of the above-mentioned laminate and the irradiation with the active energy ray. The retention time is preferably 0.5 to 5 minutes taking into consideration of alignment of the (meth)acrylate having a fluorine atom toward the side of the coating film having a fluorine atom in the ultraviolet ray curable composition.

After the ultraviolet ray curable composition is cured, the cover film is peeled off so that a laminate film having an anti-soiling layer laminated thereon can be obtained.

(Anti-Static Layer)

Next, descriptions are given for a case in which an anti-static layer having an anti-static function is laminated as a functional layer.

For the anti-static layer, it is preferable to use an ultraviolet ray curable composition for an anti-static layer which contains a compound having at least two (meth)acryloyloxy groups in the molecule, an anti-static component, and an ultraviolet ray polymerization initiator, from the viewpoint of productivity.

As for the compound having at least two (meth)acryloyloxy groups in the molecule, the aforementioned compound having at least two (meth)acryloyloxy groups can be used. Furthermore, as for the ultraviolet ray polymerization initiator, the aforementioned ultraviolet ray polymerization initiator can be used.

As the anti-static component, an electron-conductive organic compound or conductive particles, or an ion-conductive organic compound can be mentioned. The electron-conductive anti-static component such as π-conjugated conductive organic compound or conductive fine particles is preferable in that a conductive property thereof is hardly affected by changes in the environment and stable, and in particular, a good conductive property is exhibited even in a low humidity environment.

Examples of the π-conjugated conductive organic compound include polyacetylene as an aliphatic conjugated system, poly(para phenylene) as an aromatic conjugated system, polypyrrole, polythiophene, or polythiophene-based conductive polymer as a heterocyclic conjugated system, polyaniline as a heteroatom-containing conjugated system, and poly(phenylene vinylene) as a mixed conjugated system. In particular, polythiophene-based conductive polymer is preferable.

Examples of the conductive fine particles include various fine particles including carbon based, metal based, metal oxide based, and coated conductive fine particles.

Examples of the carbon fine particle include carbon powder such as carbon black, ketjen black, and acetylene black; carbon fiber such as PAN-based carbon fiber and pitch-based carbon fiber; and carbon flake of pulverized product of expanded graphite.

Examples of the metal fine particles include powders of metals such as aluminum, copper, gold, silver, nickel, chromium, iron, molybdenum, titanium, tungsten, and tantalum; powders of alloys containing these metals; metal flakes; and metal fibers of iron, copper, stainless steel, silver-plated copper, and brass.

Examples of the metal oxide fine particles include fined particles of tin oxide, antimony-doped tin oxide (ATO), indium oxide, tin-doped indium oxide (ITO), zinc oxide, aluminum-doped zinc oxide, zinc antimonate, and antimony pentoxide.

Examples of the coated conductive fine particles include conductive fine particles in which surfaces of various fine particles such as fine particles of titanium oxide (spherical or needle like), potassium titanate, aluminum borate, barium sulfate, mica, and silica are coated with anti-static components such as tin oxide, ATO, and ITO; and resin beads such as polystyrene, acrylic resin, epoxy resin, polyamide, and polyurethane subjected to surface treatment with a metal such as gold or nickel.

As the preferred conductive fine particles, metal fine particles like gold, silver, silver/palladium alloy, copper, nickel, and aluminum, and metal oxide fine particles like tin oxide, ATO, ITO, zinc oxide, aluminum-doped zinc oxide can be mentioned.

The weight average particle diameter of primary particles of the conductive fine particles is, from the viewpoint of the conductivity of an anti-static layer, 1 nm or more. Furthermore, from the viewpoint of the transparency of an anti-static layer, weight average particle diameter of primary particles of the conductive fine particles is preferably 200 nm or less, more preferably 150 nm or less, even more preferably 100 nm or less, and particularly preferably 80 nm or less. The weight average particle diameter of conductive fine particles can be measured with a light scattering method or electron micrograph images.

The amount of the ultraviolet ray polymerization initiator to be added is preferably 0.1 part by mass or more relative to 100 parts by mass of the ultraviolet ray curable composition for an anti-static layer from the viewpoint of curability by irradiation with ultraviolet rays. It is preferably 10 parts by mass or less relative to 100 parts by mass of the ultraviolet ray curable composition from the viewpoint of maintaining good color tone of an anti-static layer.

Various additives such as slip improving agent, leveling agent, inorganic fine particles, light stabilizer (such as ultraviolet rays absorber or HALS) can be added to the ultraviolet ray curable composition for an anti-static layer, if necessary. The addition amount thereof is preferably 10 parts by mass or less relative to 100 parts by mass of the ultraviolet ray curable composition for an anti-static layer from the viewpoint of transparency of the (meth)acrylic resin laminated article.

The thickness of the anti-static layer is preferably 0.1 μm or more and more preferably 0.5 μm or more. Furthermore, the thickness of the anti-static layer is preferably 10 μm or less and more preferably 7 μm or less. When the thickness of the anti-static layer is in this range, sufficient surface hardness, anti-static function, and transparency can be obtained an also warpage of the (meth)acrylic resin laminated article is reduced so that the outer appearance appears to be good.

A surface resistivity of the anti-static layer is preferably 10¹⁰Ω/□ or less and more preferably 10⁸Ω/□ or less from the viewpoint of the anti-static function of the (meth)acrylic resin laminated article.

As for the method for forming an anti-static layer, the same methods as those described for forming an anti-reflection layer described above can be mentioned.

(Adhesive Layer)

According to an embodiment of the present invention, the functional layer may be laminated onto the (meth)acrylic resin sheet via an adhesive layer, if necessary.

Examples of the resin for forming an adhesive layer include a thermoplastic resin such as a (meth)acrylic resin, a chlorinated olefin resin, a vinyl chloride-vinyl acetate copolymer resin, a maleic acid based resin, a chlorinated rubber resin, a cyclized rubber resin, a polyamide resin, a coumarone-indene resin, an ethylene-vinyl acetate copolymer resin, a polyester resin, a polyurethane resin, a styrene resin, a butyral resin, a rosin resin, and an epoxy resin.

The thermoplastic resin is preferably a resin composition in which at least one resin selected from a butyral resin, a rosin resin, and an epoxy resin is admixed with a polyamide resin. Furthermore, the thermoplastic resin can be a resin composition in which a polyurethane resin is admixed with at least one resin selected from a butyral resin, a rosin resin, or it can be a mixture of polyamide resin with a polyurethane resin admixed with at least one resin selected from a butyral resin, a rosin resin, and an epoxy resin. In any case, it is possible to obtain an adhesive layer enabling good adhesion even at a low temperature.

As a method for forming the adhesive layer, the same methods as those described for forming an anti-reflection layer described above can be mentioned.

<Composite Sheet>

The composite sheet according to an embodiment of the present invention is a sheet having a thermoplastic resin substrate and the (meth)acrylic resin laminated article laminated such that the (meth)acrylic resin sheet surface of the (meth)acrylic laminated article is in contact with one surface of the thermoplastic resin substrate. It is also possible that other (meth)acrylic resin laminated article is laminated on the other surface (opposite surface) of the thermoplastic resin substrate. At that time, the surface of the (meth)acrylic resin sheet of that (meth)acrylic resin laminated article is brought into contact with the surface of the thermoplastic resin substrate. The composite sheets laminated on both sides of the thermoplastic resin substrate may have the same structure or a different structure. Furthermore, on the other surface (opposite surface) of the thermoplastic resin substrate, a functional layer can be laminated.

Examples of the thermoplastic resin substrate include an aromatic vinyl monomer unit-containing resin such as polystyrene or styrene-methyl methacrylate copolymer, an olefin resin such as cyclized rubber resin, a polycarbonate resin such as polycarbonate, and a double-layer material composed of polycarbonate and other different material.

Examples of the configuration of the composite sheet include the following configurations.

Functional layer/(meth)acrylic resin sheet/thermoplastic resin substrate,

Functional layer/(meth)acrylic resin sheet/thermoplastic resin substrate/(meth)acrylic resin sheet/functional layer,

Functional layer/(meth)acrylic resin sheet/thermoplastic resin substrate/(meth)acrylic resin sheet,

Functional layer/(meth)acrylic resin sheet/thermoplastic resin substrate/functional layer.

Regarding the thickness of the thermoplastic resin substrate and (meth)acrylic resin sheet in the composite sheet, the thickness of the thermoplastic resin substrate is preferably in the range of from 0.5 mm to 2 mm and the thickness of the (meth)acrylic resin sheet is preferably in the range of from 0.03 mm to 0.2 mm from the viewpoint of suppressing warpage and maintaining high pencil strength.

The droop ratio of the composite sheet is preferably 0.2% or less. As the droop ratio is 0.2% or less, there is a tendency that an appearance defect like interfering shape can be suppressed without having the composite sheet in contact with an image display side. Meanwhile, the droop ratio is a value which is obtained in the same manner as the droop ratio which has been described above.

The (meth)acrylic resin sheet and functional layer of a composite sheet preferably have adhesiveness which exhibits 90% or more of the remaining ratio of the functional layer when a cross-cut peeling test is performed based on JIS K 5600-5-6. When the remaining ratio of the functional layer is 90% or more, there is a tendency that the deteriorated image recognizability accompanied with film release is suppressed when it is used as a protective panel of an image display device.

The composite sheet preferably has JIS K 7136-based haze of 0.5% or less and 50% impact fracture height of 300 mm or more according to the falling ball test based on JIS K 7211.

### EXAMPLES

Hereinbelow, the present invention is further described with reference to Examples. Meanwhile, the abbreviations of compounds that are used in Examples and Comparative Examples are as described below. Furthermore, as described hereinbelow, “parts” means “parts by mass”.

“E/MA copolymer”: ethylene-methyl acrylate copolymer (content of methyl acrylate unit: 24% by mass)
“MMA”: methyl methacrylate
“IBXMA”: isobornyl methacrylate
“IBXA”: isobornyl acrylate
“TBMA”: t-butyl methacrylate
“BA”: n-butyl acrylate
“NPG”: dimethacrylic acid neopentyl glycol
“HPP”: perhexyl PV (t-hexylperoxypyvalate, purity of 70% by mass)
“PBPV”: perbutyl PV (t-butylperoxypyvalate, purity of 70% by mass)
“AOT”: sodium dioctylsulfosuccinate
“urethane(meth)acrylate 1”: urethane(meth)acrylate which is obtained by reaction of 3 moles of 3-acryloyloxy-2-hydroxypropyl(meth)acrylate per mole of polyisocyante obtained by termierzation of hexamethylene diisocyanate,
“diacrylate 1”: 1,6-hexane diol diacrylate,
“polyacrylate 1”: mixture of pentaerythritol triacrylate (50 to 70% by mass) and pentaerythritol tetraacrylate (50 to 30% by mass),
“polyacrylate 2”: mixture of dipentaerythritol hexaacrylate (60 to 70% by mass) and dipentaerythritol pentaacrylate (40 to 30% by mass),
“TDPO”: 2,4,6-trimethylbenzoyl-diphenyl-phosphine oxide,
“Phosphoric acid ester 1”: mixture of monoethyl acid phosphate (50% by mass), diethyl acid phosphate, and triethyl acid phosphate (50% by mass),
“Phosphoric acid ester 2”: mixture of monoethyl acid phosphate (50% by mass), diethyl acid phosphate, and triethyl acid phosphate (50% by mass),

Various evaluations in the embodiments and examples of the present invention were performed according to the following methods.

(1) Total Light Transmittance and Haze

A test sample (width and height; 45 to 65 mm) was cut from a (meth)acrylic resin laminated article and composite sheet and used for measurement of total light transmittance and haze. Total light transmittance and haze of the (meth)acrylic resin laminated article and composite sheet were measured in accordance with a method described in JIS K 7136 by using HAZE METER NDH2000 (trade name), manufactured by Nippon Denshoku Industries Co., Ltd.

(2) Impact Resistance

Evaluation of the impact resistance of the (meth)acrylic resin laminated article and composite sheet was performed by a falling ball test. Evaluation of the impact strength according to a falling ball test is based on JIS K 7211-1, and it is performed according to the following method at the falling ball conditions described below.

A test sample was placed on a support such that the center of a hole in the support is in match with the center of the test sample. Two lateral sides of the test sample were fixed onto the support by using a cellophane tape, and then a stainless steel ball was dropped toward the center of the test sample. The dropping height was changed by unit of 25 mm, and by having 20 test samples for each dropping height, the height at which 50% or more of the test sample show a crack (50% impact fracture height) was obtained.

<Conditions for Falling Ball Test>

Size of test sample: square with single side length of 50 mm

Support size: acrylic plate with 5 mm thickness in which a circular hole with diameter of 20 mm is formed

Size of falling ball: stainless steel ball (ball diameter of 20.0 mm φ, mass of 18.5 g)

Temperature of measurement atmosphere: 23° C.

Relative humidity of measurement atmosphere: 50%

Time for keeping test sample before measurement in measurement atmosphere: 24 hours or longer.

(3) Abrasion Resistance

A circular pad having a diameter of 25.4 mm equipped with #000 steel wool was put on the surface of the functional layer of a (meth)acrylic resin laminated article and a surface of the functional layer of a composite sheet, and forced to reciprocate 100 times over a distance of 20 mm under the load of 9.8 N for an abrasion treatment. Haze value before the abrasion treatment (haze value before abrasion) and haze value after the abrasion treatment (haze value after abrasion) were obtained. The abrasion resistance was evaluated according to a change in haze [ΔHaze (%)] which is obtained by the following equation.

[ΔHaze (%)]=[Haze value after abrasion (%)]−[Haze value before abrasion (%)]

(4) Droop Ratio

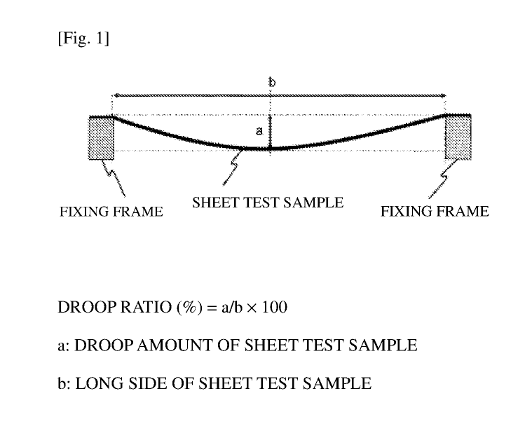

The droop ratio of the (meth)acrylic resin laminated article and composite sheet was obtained as follows: the (meth)acrylic resin laminated article and composite sheet are kept at the following conditions for 24 hours in high temperature and high humidity environment of 50° C. and relative humidity of 90% and they are again kept for 5 hours in a typical environment of 23° C. and relative humidity of 50%, thereafter, the droop amount (a) of a test sample is measured and the ratio of the droop amount (a) relative to the long side (b) of a sheet test sample before keeping in a high temperature and high humidity environment (length of the part not overlapped with fixing frame: 55 mm) was obtained according to the following equation (see FIG. 1).

Droop ratio (%)=Droop amount (a)÷Long side of test sample (b)×100

<Conditions for Measuring Droop Ratio>

On the center part of a glass base, a fixing jig (fixing frame) was attached by using a double-sided tape. Subsequently, on the center part of the fixing jig, a test sample with pre-determined size was attached by using a double-sided tape to prepare a sample for measuring water absorption displacement. The obtained sample for measuring water absorption displacement was allowed to stand for 24 hours in a predetermined environment with high temperature and high humidity, and then allowed to stand again for 5 hours in a predetermined ordinary environment. Thereafter, by using a laser displacement sensor (LK-085) manufactured by KEYENCE CORPORATION, the droop amount of the center part of the sample in vertical direction (water absorption displacement amount) was measured. Regarding the droop amount, the degree of vertical displacement of center part of the sheet test sample when compared to four corners of the sheet test sample was measured. Meanwhile, the displacement toward the glass base was designated as ‘plus’, and the displacement toward the opposite side was designated as ‘minus.’
Size of test sample: height of 45 mm and width of 65 mm
Fixing jig: as a rectangular frame with width of 5 mm, a metal frame with thickness of 3 mm in which the short side of the external part of the frame is 45 mm, the long side of the external part of the frame is 65 mm, the short side of the internal part of the frame is 35 mm, and the long side of the internal part of the frame is 55 mm,
Base: glass plate with height of 80 mm, width of 80 mm, and thickness of 5 mm
Double-sided tape: double-sided tape with width of 5 mm manufactured by 3M Company, trade name: VHB™
High temperature and high humidity environment: 50° C. and relative humidity of 90%
Ordinary environment: 23° C. and relative humidity of 50%.

(5) Adhesiveness

The adhesiveness of the functional layer in the (meth)acrylic resin laminated article and composite sheet was evaluated according to the following cross-cut peeling test.

In an environment with temperature of 23±2° C. and relative humidity of 50±5%, 25-mark cross-cut test was performed for 4 spots in conformity with JIS K 5600-5-6. Among 100 marks in total, the number of the marks not exhibiting any peeling was obtained.

### Preparation Example 1

### Preparation of Stock Syrup 1

To a reactor equipped with a condenser, a thermometer, and a stirrer, a mixture containing 0.038 part of E/MA copolymer, 60 parts of MMA, 24 parts of IBXMA, 6.5 parts of IBXA, 8.2 parts of TBMA, 1.1 parts of BA, and 0.08 part of NPG was added as shown in Table 1, and after bubbling with nitrogen gas under stirring, heating was initiated. When the liquid temperature is 60° C., 0.034 part of HPP was added, the liquid temperature was again raised to 100° C., and it was maintained at the same temperature for 13 minutes. Subsequently, the liquid temperature was cooled to room temperature to obtain the stock syrup 1. Content of the polymer in the stock syrup 1 was 20% by mass.

TABLE 1
Composition of stock syrup 1 (parts)

| (C1) | (C2) | (C3) | (a) | | (b) | Copolymer (B) |
|---|---|---|---|---|---|---|
| MMA | IBXMA | TBMA | IBMA | BA | NPG | E/MA copolymer |
| 65 | 22 | 8.2 | 3.5 | 1.1 | 0.08 | 0.038 |

### Example 1

Two pieces of glass plate (height of 300 mm, width of 300 mm, and thickness of 5 mm) were arranged to face each other, and their peripheries were sealed by using a gasket made of soft polyvinyl chloride to produce a mold for cast polymerization.

To 68 parts of the stock syrup 1, 28.7 parts of MMA, 3 parts of BA, and 0.3 part of NPG were added to obtain a diluted syrup. By further adding 0.08 part of PBPV, 0.03 part of triphenylphosphine (the compound (C)), and 0.08 part of AOT (the releasing agent (D)), a polymerizable material was obtained.

After adding the polymerizable material into the mold, the space between two opposite glass plates was adjusted to 1.6 mm. Subsequently, the mold was heated for 30 minutes in a water bath at 84° C. and then heated again for 30 minutes in an air furnace at 130° C. to have polymerization and curing of the polymerizable material in the mold. Accordingly, a sheet-like polymer was obtained. After that, the mold was cooled, and the sheet-like polymer was released from the glass plate to obtain an acrylic resin sheet with thickness of 1 mm.

20 Parts of urethane(meth)acrylate 1, 30 parts of diacrylate 1, 25 parts of polyacrylate 1, 25 parts of polyacrylate 2, and 2 parts of TDPO were admixed with one another to obtain a curable composition for forming a functional layer. After heating the curable composition to 50° C., a single surface of the above acrylic resin sheet was coated with the curable composition, and the PET surface side of a PET film having an easy adhesion layer was overlappedly laminated on the coated surface to obtain a laminate before curing.

The laminate before curing was allowed to stand for 60 seconds while it has been heated to 43° C., and then passed through, at the rate of 2.5 m/minute, a position which is 20 cm below a metal halide lamp with output of 9.6 kW such that the irradiation is performed via the PET film. By curing the curable composition under conditions including accumulated light amount of 570 mJ/cm² and peak light intensity of 220 mW/cm², a laminate after curing in which a functional layer is formed thereon was obtained. Thereafter, the PET film was released from the laminate after curing to obtain a (meth)acrylic resin laminated article. The film thickness of the functional layer in the obtained (meth)acrylic resin laminated article was 13 μm. The evaluations results are shown in Table 2.

TABLE 2

| | | | Example 1 | Example 2 | Example 3 | Example 4 | Example 5 | Example 6 | Example 7 |
|---|---|---|---|---|---|---|---|---|---|
| Diluted syrup | Stock | Type | 1 | 1 | 1 | 1 | 1 | 1 | 1 |
| composition | syrup | Amount | 68 | 68 | 68 | 68 | 68 | 68 | 68 |

| (parts) | | BA | 3 | 1.5 | 2 | 3 | 4 | 3 | 2 |
|---|---|---|---|---|---|---|---|---|---|
| | | NPG | 0.3 | 0.5 | 0.5 | 0.5 | 0.5 | 1.0 | 2 |
| | | MMA | 28.7 | 30 | 29.5 | 28.5 | 27.5 | 28 | 28 |
| Monomer | (a) unit | IBXA | 2.4 | 2.4 | 2.4 | 2.4 | 2.4 | 2.4 | 2.4 |
| composition of | | BA | 3.7 | 2.2 | 2.7 | 3.7 | 4.7 | 3.7 | 2.7 |
| (meth)acrylic | | Total | 6.1 | 4.6 | 5.1 | 6.1 | 7.1 | 6.1 | 5.1 |
| polymer (A) | (b) unit | NPG | 0.4 | 0.6 | 0.6 | 0.6 | 0.6 | 1.1 | 2.1 |
| (% by mass) | | Total | 0.4 | 0.6 | 0.6 | 0.6 | 0.6 | 1.1 | 2.1 |
| | (c1) unit | MMA | 72.9 | 74.2 | 73.7 | 72.7 | 71.7 | 72.2 | 72.2 |
| | (c2) unit | IBXMA | 15.1 | 15.1 | 15.1 | 15.1 | 15.1 | 15.1 | 15.1 |
| | (c3) unit | TBMA | 5.5 | 5.5 | 5.5 | 5.5 | 5.5 | 5.5 | 5.5 |

| | | | | | | | | |
|---|---|---|---|---|---|---|---|---|
| Radical polymerization | PBPV | 0.08 | 0.08 | 0.08 | 0.08 | 0.08 | 0.08 | 0.08 |
| initiator (parts) | | | | | | | | |

| | | | | | | | | |
|---|---|---|---|---|---|---|---|---|
| Aids (parts) | Triphenyl | 0.03 | 0.03 | 0.03 | 0.03 | 0.03 | 0.03 | 0.03 |
| | phosphine | | | | | | | |
| | AOT | 0.08 | 0.08 | 0.08 | 0.08 | 0.08 | 0.08 | 0.08 |
| | Phosphoric | 0 | 0 | 0 | 0 | 0 | 0 | 0 |
| | acid ester 2 | | | | | | | |
| | Phosphoric | 0 | 0 | 0 | 0 | 0 | 0 | 0 |
| | acid ester 1 | | | | | | | |

| | | | | | | | | |
|---|---|---|---|---|---|---|---|---|
| Evaluation | Haze (%) | 0.1 | 0.1 | 0.1 | 0.1 | 0.1 | 0.1 | 0.1 |
| results | Total light | 92 | 92 | 92 | 92 | 92 | 92 | 92 |
| | transmission (%) | | | | | | | |
| | 50% Impact fracture | 400 | 400 | 400 | 400 | 375 | 400 | 400 |
| | height (mm) | | | | | | | |
| | Δ Haze (%) | 0.1 | 0.1 | 0.1 | 0.1 | 0.1 | 0.1 | 0.1 |
| | Droop ratio (%) | 0.18 | 0.13 | 0.15 | 0.16 | 0.18 | 0.16 | 0.13 |
| | Adhesiveness (%) | 100 | 100 | 100 | 100 | 100 | 100 | 100 |

| | | | Example 8 | Example 9 | Example 11 | Example 12 | Example 13 |
|---|---|---|---|---|---|---|---|
| Diluted syrup | Stock | Type | 1 | 1 | 1 | 1 | 1 |
| composition | syrup | Amount | 68 | 68 | 68 | 68 | 68 |

| (parts) | | BA | 3 | 4 | 3 | 3 | 4 |
|---|---|---|---|---|---|---|---|
| | | NPG | 2 | 2 | 3 | 3 | 3 |
| | | MMA | 27 | 26 | 26 | 26 | 25 |
| Monomer | (a) unit | IBXA | 2.4 | 2.4 | 2.4 | 2.4 | 2.4 |
| composition of | | BA | 3.7 | 4.7 | 3.7 | 3.7 | 4.7 |
| (meth)acrylic | | Total | 6.1 | 7.1 | 6.1 | 6.1 | 7.1 |
| polymer (A) | (b) unit | NPG | 2.1 | 2.1 | 3.1 | 3.1 | 3.1 |
| (% by mass) | | Total | 2.1 | 2.1 | 3.1 | 3.1 | 3.1 |
| | (c1) unit | MMA | 71.2 | 70.2 | 70.2 | 70.2 | 69.2 |
| | (c2) unit | IBXMA | 15.1 | 15.1 | 15.1 | 15.1 | 15.1 |
| | (c3) unit | TBMA | 5.5 | 5.5 | 5.5 | 5.5 | 5.5 |

| | | | | | | |
|---|---|---|---|---|---|---|
| Radical polymerization | PBPV | 0.08 | 0.08 | 0.08 | 0.08 | 0.08 |
| initiator (parts) | | | | | | |

| | | | | | | |
|---|---|---|---|---|---|---|
| Aids (parts) | Triphenyl | 0.03 | 0.03 | 0.03 | 0.03 | 0.03 |
| | phosphine | | | | | |
| | AOT | 0.08 | 0.08 | 0.08 | 0.08 | 0.08 |
| | Phosphoric | 0 | 0 | 0 | 0.06 | 0 |
| | acid ester 2 | | | | | |
| | Phosphoric | 0 | 0 | 0.06 | 0 | 0 |
| | acid ester 1 | | | | | |

| | | | | | | |
|---|---|---|---|---|---|---|
| Evaluation | Haze (%) | 0.1 | 0.1 | 0.1 | 0.1 | 0.1 |
| results | Total light | 92 | 92 | 92 | 92 | 92 |
| | transmission (%) | | | | | |
| | 50% Impact fracture | 400 | 400 | 400 | 400 | 400 |
| | height (mm) | | | | | |
| | Δ Haze (%) | 0.1 | 0.1 | 0.1 | 0.1 | 0.1 |
| | Droop ratio (%) | 0.15 | 0.16 | 0.16 | 0.16 | 0.16 |
| | Adhesiveness (%) | 100 | 100 | 100 | 100 | 97 |

### Examples 2 to 13

A (meth)acrylic resin laminated article was produced in the same manner as Example 1 except that composition of a diluted syrup composition, monomer composition of the (meth)acrylic polymer (A), and aids are modified to those shown in Table 2. The results are shown in Table 2.

### Example 14

An acrylic resin sheet with thickness of 0.1 mm was obtained in the same manner as Example 1 except that the space between opposing glass plates of a mold is adjusted to 0.3 mm. By using the obtained acrylic resin sheet, a (meth)acrylic resin laminated article was obtained in the same manner as Example 1. Film thickness of the functional layer in the obtained (meth)acrylic resin laminated article was 13 μm.

20 Parts of urethane(meth)acrylate 1, 30 parts of diacrylate 1, 25 parts of polyacrylate 1, 25 parts of polyacrylate 2, and 2 parts of TDPO were admixed with one another to obtain an adhesive composition.

Subsequently, on a single surface of a polycarbonate sheet with thickness of 0.6 mm, the adhesive composition which has been heated to 50° C. was coated, and by further laminating overlappedly the coated surface with the above (meth)acrylic resin laminated article such that the surface of the article not laminated with a functional layer was laminated on the coated surface, a composite sheet before curing was obtained.

The composite sheet before curing was allowed to stand for 60 seconds while it has been heated to 43° C., and then to pass through, at the rate of 2.5 m/minute, a position which is 20 cm below a metal halide lamp with output of 9.6 kW such that the irradiation is performed via the (meth)acrylic resin laminated article. By curing the adhesive composition under conditions including accumulated light amount of 570 mJ/cm² and peak light intensity of 220 mW/cm², a composite sheet having the (meth)acrylic resin laminated article laminated on one surface of a polycarbonate sheet was obtained. The same process was performed for the other surface of a polycarbonate sheet not laminated with the (meth)acrylic resin laminated article, and thus a composite sheet having the (meth)acrylic resin laminated article laminated on both surfaces of a polycarbonate sheet was obtained.

The total light transmittance of the obtained composite sheet was 88% and the haze was 0.8%. Furthermore, the 50% fracture height of the composite sheet was 500 mm, Δhaze after abrasion test was 0.1%, the droop ratio was 0.1%, and the adhesiveness was 100%.

### Comparative Examples 1 to 4

A (meth)acrylic resin laminated article was produced in the same manner as Example 1 except that composition of a diluted syrup composition and monomer composition of the (meth)acrylic polymer are modified to those shown in Table 3. The results are shown in Table 3.

In Comparative Example 1, the monomer (b) unit is less than 0.3% by mass, and thus the droop ratio (water absorption displacement amount) of the (meth)acrylic resin laminated article was high.

In Comparative Example 2, the monomer (b) unit was contained in an amount of more than 3.2% by mass, and thus the adhesiveness between the functional layer (cured layer) and (meth)acrylic resin sheet was insufficient.

In Comparative Example 3, the acrylic acid ester (a) unit was less than 4.5% by mass in the (meth)acrylic resin laminated article, and thus the adhesiveness between the functional layer and (meth)acrylic resin sheet was insufficient.

In Comparative Example 4, the acrylic acid ester (a) unit was contained in an amount of more than 7.5% by mass, and thus the droop ratio (water absorption displacement amount) of the (meth)acrylic resin laminated article was high.

TABLE 3

| | | | Comparative | Comparative | Comparative | Comparative |
|---|---|---|---|---|---|---|
| | | | Example 1 | Example 2 | Example 3 | Example 4 |
| Diluted syrup | Stock | Type | 1 | 1 | 1 | 1 |
| composition | syrup | Amount | 68 | 68 | 68 | 68 |

| (parts) | | BA | 3 | 3 | 1 | 5 |
|---|---|---|---|---|---|---|
| | | NPG | 0 | 4 | 0.5 | 0.5 |
| | | MMA | 29 | 25 | 30.5 | 26.5 |
| Monomer | (a) unit | IBXA | 2.4 | 2.4 | 2.4 | 2.4 |
| composition of | | BA | 3.7 | 3.7 | 1.7 | 5.7 |
| (meth)acrylic | | Total | 6.1 | 6.1 | 4.1 | 8.1 |
| polymer (A) | (b) unit | NPG | 0.1 | 4.1 | 0.6 | 0.6 |
| (% by mass) | | Total | 0.1 | 4.1 | 0.6 | 0.6 |
| | (c1) unit | MMA | 73.2 | 69.2 | 74.7 | 70.7 |
| | (c2) unit | IBXMA | 15.1 | 15.1 | 15.1 | 15.1 |
| | (c3) unit | TBMA | 5.5 | 5.5 | 5.5 | 5.5 |

| | | | | | |
|---|---|---|---|---|---|
| Radical polymerization | PBPV | 0.08 | 0.08 | 0.08 | 0.08 |
| initiator (parts) | | | | | |

| | | | | | |
|---|---|---|---|---|---|
| Aids (parts) | Triphenyl | 0.03 | 0.03 | 0.03 | 0.03 |
| | phosphine | | | | |
| | AOT | 0.08 | 0.08 | 0.08 | 0.08 |

| | | | | | |
|---|---|---|---|---|---|
| Evaluation | Haze (%) | 0.1 | 0.1 | 0.1 | 0.1 |
| results | Total light | 92 | 92 | 92 | 92 |
| | transmittance (%) | | | | |
| | 50% Impact fracture | 400 | 400 | 400 | 375 |
| | height (mm) | | | | |
| | ΔHaze (%) | 0.1 | 0.1 | 0.1 | 0.1 |
| | Droop ratio (%) | 0.33 | 0.18 | 0.21 | 0.32 |
| | Adhesiveness (%) | 100 | 20 | 34 | 100 |

1. A (meth)acrylic polymer (A) comprising:
4.5 to 7.5% by mass of a monomer (a) unit;
0.3 to 3.2% by mass of a monomer (b) unit; and
89.3 to 95.2% by mass of a monomer (c) unit,
wherein
the monomer (a) unit is an acrylic acid ester unit having a hydrocarbon group with 1 to 11 carbon atoms and one ethylenically unsaturated bond in the molecule,
the monomer (b) unit is a monomer unit having two or more ethylenically unsaturated bonds in the molecule, and
the monomer (c) unit is a (meth)acrylic acid ester unit other than the monomer units.

2. The (meth)acrylic polymer (A) according to claim 1, wherein
the monomer (c) unit comprises a monomer (c1) unit, a monomer (c2) unit, and a monomer (c3),
the monomer (c1) unit being a methyl methacrylate unit,
the monomer (c2) unit being a methacrylic acid ester unit having an alicyclic hydrocarbon group with 6 to 20 carbon atoms,
and the monomer (c3) unit being a methacrylic acid ester unit other than the methacrylic acid ester (c2) unit a methacrylic acid ester unit having a hydrocarbon group with 3 to 10 carbon atoms.

3. The (meth)acrylic polymer (A) according to claim 2, wherein
the monomer (c2) is isobornyl methacrylate and the monomer (c3) is t-butyl methacrylate.

4. A (meth)acrylic resin composition comprising
100 parts by mass of the (meth)acrylic polymer (A) according to claim 1 and 0.002 to 0.7 part by mass of an olefin-alkyl(meth)acrylate copolymer (B).

5. The (meth)acrylic resin composition according to claim 4, wherein
the olefin-alkyl(meth)acrylate copolymer (B) is an ethylene-alkyl(meth)acrylate copolymer (B-1).

6. The (meth)acrylic resin composition according to claim 5, wherein
the ethylene-alkyl(meth)acrylate copolymer (B-1) is an ethylene-alkyl acrylate copolymer (B-2).

7. The (meth)acrylic resin composition according to claim 6, wherein
content of the alkyl acrylate unit in the ethylene-alkyl acrylate copolymer (B-2) is 15 to 40% by mass.

8. A (meth)acrylic resin sheet comprising
the (meth)acrylic polymer (A) according to claim 1.

9. A (meth)acrylic resin sheet comprising
the (meth)acrylic resin composition according to claim 4.

10. A (meth)acrylic resin laminated article comprising
the (meth)acrylic resin sheet according to claim 8 and a functional layer laminated on at least one surface of the (meth)acrylic resin sheet.

11. A (meth)acrylic resin laminated article comprising
the (meth)acrylic resin sheet according to claim 8 and a functional layer laminated on both surfaces of the (meth)acrylic resin sheet.

12. A composite sheet comprising
a thermoplastic resin substrate and the (meth)acrylic resin laminated article according to claim 10 that is laminated on at least one surface of the thermoplastic resin substrate, wherein
lamination is performed such that the (meth)acrylic resin sheet surface of the (meth)acrylic laminated article is in contact with the thermoplastic resin substrate surface.

13. A composite sheet comprising
a thermoplastic resin substrate, the (meth)acrylic resin laminated article according to claim 10 that is laminated on one surface of the thermoplastic resin substrate, and a functional layer that is laminated on the other surface of the thermoplastic resin substrate, wherein
lamination is performed such that the (meth)acrylic resin sheet surface of the (meth)acrylic resin laminated article is in contact with the thermoplastic resin substrate surface.

14. The (meth)acrylic resin laminated article according to claim 10, wherein
the droop ratio of the (meth)acrylic resin laminated article is 0.2% or less when it is allowed to stand for 24 hours in an environment with 50° C. and relative humidity of 90% and for 5 hours in an environment with 23° C. and relative humidity of 50%, and the remaining ratio of a functional layer after performing a cross-cut peeling test based on JIS K 5600-5-6 is 90% or more.

15. The (meth)acrylic resin laminated article according to claim 11, wherein
the droop ratio of the (meth)acrylic resin laminated article is 0.2% or less when it is allowed to stand for 24 hours in an environment with 50° C. and relative humidity of 90% and for 5 hours in an environment with 23° C. and relative humidity of 50%, and the remaining ratio of a functional layer after performing a cross-cut peeling test based on JIS K 5600-5-6 is 90% or more.

16. The composite sheet according to claim 12, wherein
the droop ratio of the composite sheet is 0.2% or less when it is allowed to stand for 24 hours in an environment with 50° C. and relative humidity of 90% and for 5 hours in an environment with 23° C. and relative humidity of 50%, and the remaining ratio of a functional layer after performing a cross-cut peeling test based on JIS K 5600-5-6 is 90% or more.

17. The composite sheet according to claim 13, wherein
the droop ratio of the composite sheet is 0.2% or less when it is allowed to stand for 24 hours in an environment with 50° C. and relative humidity of 90% and for 5 hours in an environment with 23° C. and relative humidity of 50%, and the remaining ratio of the functional layer after performing a cross-cut peeling test based on JIS K 5600-5-6 is 90% or more.

18. The (meth)acrylic resin laminated article according to claim 10, wherein
the functional layer is a layer having at least one function selected from anti-reflection function, anti-glare function, hard coat function, anti-static function, and anti-soiling function.

19. The composite sheet according to claim 12, wherein
the functional layer is a layer having at least one function selected from anti-reflection function, anti-glare function, hard coat function, anti-static function, and anti-soiling function.

20. The composite sheet according to claim 12, wherein
thickness of the thermoplastic resin substrate is 0.5 mm to 2 mm and thickness of the (meth)acrylic resin sheet is 0.03 mm to 0.2 mm.
